(19) United States
(12) Patent Application Publication
(10) Pub. No.: US 2019/0284509 A1
(43) Pub. Date: Sep. 19, 2019

(54) HAND DISHWASHING DETERGENT COMPOSITION

(71) Applicant: The Procter & Gamble Company, Cincinnati, OH (US)

(72) Inventors: Denis Alfred Gonzales, Brussels (BE); Jean-Luc Philippe Bettiol, Etterbeek (BE)

(21) Appl. No.: 16/352,060

(22) Filed: Mar. 13, 2019

(30) Foreign Application Priority Data
Mar. 13, 2018 (EP) 18161364.7

(51) Int. Cl. C11D 3/382; C11D 1/94

(52) U.S. Cl. CPC C11D 3/382; C11D 1/29; C11D 1/94

(57) ABSTRACT

The present invention is directed to a detergent composition having enhanced suds boosting and/or increased suds longevity, especially in the presence of greasy soils, wherein the detergent composition is a hand dishwashing detergent composition. The composition includes a specific surfactant system including an anionic surfactant and a primary co-surfactant, wherein the weight ratio of the anionic surfactant to the primary co-surfactant is less than about 9:1, and a plant derived protein or blend of plant derived proteins derived from a Leguminous plant family.

### REFERENCE TO A SEQUENCE LISTING

This application contains Sequence Listings in computer readable form. The computer readable form is incorporated herein by reference.

### FIELD OF THE INVENTION

The present invention relates to a detergent composition comprising a specific surfactant system and a plant derived protein or blend of plant derived proteins derived from a Leguminous plant family, preferably a Pulse protein, preferably selected from the group consisting of a Pea protein, a Chickpea protein, a Lentil protein, a Bean protein, and mixtures thereof, preferably a Pea protein, wherein the detergent composition is a hand dishwashing detergent composition.

### BACKGROUND OF THE INVENTION

Detergent compositions should provide good soil and/or grease cleaning while presenting a good sudsing profile in particular a long-lasting suds profile especially in the presence of greasy soils. Users usually see suds as an indicator of the performance of the detergent composition. Moreover, the user of a detergent composition may also use the sudsing profile and the appearance of the suds (e.g., density) as an indicator that the wash solution still contains sufficient active cleaning ingredients. This is particularly the case for manual washing, also referred to herein as hand-washing, where the user usually doses the detergent composition depending on the suds remaining and renews the wash solution when the suds subsides or when the suds does not look thick enough. Thus, a detergent composition, particularly a hand dishwashing detergent composition that generates or maintains low density suds during the dishwashing process would tend to be replaced by the user more frequently than is necessary. Thus, it is desirable for a detergent composition to provide a “good sudsing profile”, which includes good suds height and/or density as well as good suds duration (i.e., increased suds longevity) during the initial mixing of the composition with water and/or during the entire washing operation. In recent years, users also desire that hand dishwashing detergents are formulated with ingredients that will have minimal negative impact on the environment and/or the health of the users.

Suds can be formed and stabilized by surfactants and/or proteins. By co-formulating with naturally derived Leguminous plant proteins, it is possible to reduce the levels of surfactants utilized and mitigate against the negative environmental impact while still maintaining a good sudsing profile. Several families of plant derived proteins are naturally derived from Leguminous plant family (Leguminosae) including Pulse proteins, which are dried edible seeds of certain plants in the Legume family and a rich source of proteins. The United Nations Food and Agriculture Organization (FAO) recognizes 11 types of Pulse proteins, with the four main types of Pulse proteins being Pea protein, Chickpea protein, Lentil protein, and Bean protein. The Pulse proteins can be readily isolated from pulse seed sources using multi-step process, such as for example, as described in PCT Publication Nos. WO2016/01515A1, WO2014/190418, and WO2014/053052. The Pulse proteins are capable of foaming and are typically used in the development of food products (WO 2013/159192A1), nutritional supplements, and industrial and cosmetic applications (WO 2011/137524A1). However, the inclusion of Pulse proteins, particularly Pulse protein isolates, in the context of hand dishwashing detergent compositions for improving sudsing profile, particularly increased suds longevity, especially in the presence of greasy soil, has not been disclosed.

Accordingly, the need remains for an improved detergent composition comprising a plant derived protein derived from a Leguminous plant, preferably a Pulse protein, and a specific surfactant system, which provides a good sudsing profile, in particular enhanced suds boosting and/or increased suds longevity, especially in the presence of greasy soils. The composition may also provide good cleaning, particularly good grease emulsification. It is desirous to reduce the levels of surfactants in the composition versus traditional formulations without negatively impacting sudsing, grease cleaning and/or emulsification profile. The Applicant discovered that some or all of the above-mentioned needs can be at least partially fulfilled through the improved detergent composition as described herein below.

### SUMMARY OF THE INVENTION

The present invention meets one or more of these needs based on the surprising discovery that by formulating a detergent composition comprising a specific surfactant system working in synergy with a plant derived protein or blend of plant derived proteins derived from a Leguminous plant family, preferably a Pulse protein, wherein the detergent composition is a hand dishwashing detergent composition, such a composition exhibits good sudsing profile, particularly desirable suds volume and/or increased suds longevity, especially in the presence of greasy soils. The composition also provides good grease cleaning and emulsification benefits.

According to a first aspect, the present invention is directed to a detergent composition comprising: a) from about 1 wt % to about 60 wt %, preferably from about 5 wt % to about 50 wt %, more preferably from about 8 wt % to about 45 wt %, even more preferably from about 15 wt % to about 40 wt %, by weight of the composition of a surfactant system; and b) from about 0.1 wt % to about 10 wt %, preferably from about 0.5 wt % to about 5 wt %, by weight of the composition of a plant derived protein or blend of plant derived proteins derived from a Leguminous plant family, preferably a Pulse protein, wherein the detergent composition is a hand dishwashing detergent composition. The surfactant system comprises: i) an anionic surfactant, preferably the anionic surfactant is selected from the group consisting of alkyl sulfate, alkyl alkoxy sulfate, and mixtures thereof; and ii) a primary co-surfactant selected from the group consisting of an amphoteric surfactant preferably an amine oxide surfactant, a zwitterionic surfactant preferably a betaine surfactant, and mixtures thereof, preferably the primary co-surfactant is an amine oxide surfactant, wherein the weight ratio of the anionic surfactant to the primary co-surfactant is less than 9:1, preferably from 5:1 to 1:1, more preferably from 4:1 to 2:1. Preferably the Pulse protein is selected from the group consisting of a Pea protein, a Chickpea protein, a Lentil protein, a Bean protein and mixtures thereof, preferably the Pulse protein is a Pea protein. Preferably, the composition is essentially free, preferably free, of animal-, fungal- and/or bacterial-derived proteins. It has been surprisingly found that the composition of the present invention creates long lasting suds under a hand dishwashing operation, especially in the presence of greasy soils.

In another aspect, the present invention is directed to a method of manually washing dishware comprising the steps of delivering a composition according to the claims to a volume of water to form a wash liquor and immersing the dishware in the wash liquor, or delivering a composition according to the claims directly onto the dishware or cleaning implement and using the cleaning implement to clean the dishware. When the composition of the invention is used according to this method a good sudsing profile, with a long-lasting effect is achieved, especially in the presence of greasy soils.

There is also provided the use of a detergent composition of the claims to provide increased suds longevity of the composition, especially in the presence of greasy soils, wherein the detergent composition is a hand dishwashing detergent composition.

One aim of the present invention is to provide a detergent composition which can exhibit good sudsing profile, in particular enhanced suds boosting and/or increased suds longevity, especially in the presence of greasy soils, preferably over the entire dishwashing process, wherein the detergent composition is a hand dishwashing detergent composition.

Another aim of the present invention is to provide such a composition having good tough food cleaning (e.g., cooked-, baked- and burnt-on soils) and/or good grease cleaning.

Yet another aim of the present invention is to provide a use of a composition, comprising a plant derived protein or blend of plant derived proteins which function to increase suds longevity and/or facilitate the reduction of surfactants in the formulation. Thus, it is an advantage of the invention to minimize production costs and/or reduce negative environmental impact.

A further aim of the present invention is to provide such a composition comprising a plant derived protein or blend of plant derived proteins, in a form which is water soluble and/or transparent resulting in improved water solubility and/or transparency of the composition, particularly in an aqueous environment.

Yet a further aim of the present invention is to provide such a composition comprising a plant derived protein or blend of plant derived proteins resulting in a composition that has low or is essentially free of phytic acid and/or protein-bound carbohydrate. This is believed to contribute to improved water solubility of the composition and/or improved plant derived protein performance to enhance sudsing profile.

The elements of the composition of the invention described in relation to the first aspect of the invention apply mutatis mutandis to the other aspects of the invention.

These and other features, aspects and advantages of the present invention will become evident to those skilled in the art from the detailed description which follows.

### DETAILED DESCRIPTION OF THE INVENTION

### Definitions

As used herein, the articles “a” and “an” when used in a claim, are understood to mean one or more of what is claimed or described.

As used herein, the term “amino acid identity” means the identity between a polypeptide subunit or a protomer of the vegetable protein and the reference amino acid sequence and is expressed in terms of the identity or similarity between the subunit or the protomer and the sequence. Sequence identity can be measured in terms of percentage identity; the higher the percentage, the more identical the sequences are. The percentage identity is calculated over the length of comparison. For example, Pea Globulin proteins fall into two distinct structural groups of Pea Legumin with sedimentation coefficient of 11S (˜320-400 kDa) and Pea Vincilin with sedimentation coefficient of 7S (˜145-190 kDa). The Pea Legumin (11S) is the predominate storage protein in the Pea family and the mature Pea Legumin contains six subunits or protomers in which each protomer is comprised of two polypeptides linked by a disulphide bond. The amino acid identity of a Pea Legumin is typically calculated over the entire length of a subunit or protomer aligned against the entire length of the reference sequence (e.g., SEQ ID NOs: 1-8). Methods of alignment of sequences for comparison are well known in the art and identity can be calculated by many known methods. Various programs and alignment algorithms are described in the art. It should be noted that the terms ‘sequence identity’ and ‘sequence similarity’ can be used interchangeably. For polypeptide sequence comparison the following settings can be used: Alignment algorithm: Needleman and Wunsch, J. Mol. Biol. 1970, 48: 443-453. As a comparison matrix for amino acid similarity the Blosum62 matrix is used (Henikoff S. and Henikoff J. G., P.N.A.S. USA 1992, 89: 10915-10919). The following gap scoring parameters are used: Gap penalty: 12, gap length penalty: 2, no penalty for end gaps.

As used herein the term “animal protein” means protein that is derived from meat, or dairy products such as milk, eggs and the like.

As used herein the term “bacterial-derived protein” means protein that are produced by bacteria.

As used herein the term “fungal-derived protein” means protein that are derived from fungi.

As used herein the term “plant derived protein” or “blend of plant derived proteins” mean a protein that is derived from plant or Leguminous plant sources. As used herein the term “plant derived protein” or “blend of plant derived proteins” also mean a protein composition derived from plant sources that is uncontaminated by animal, fungal or bacterial products or any animal-, fungal, or bacterial-derived peptides that are derived from the fermentation media or the purification media.

As used herein, the term “dishware” includes cookware and tableware.

As used herein, the term “essentially free” when used to described a component means less than 0.005% by weight of the total composition of the component is present in the detergent composition.

As used herein, the term “hand dishwashing detergent composition” refers to a composition or formulation designed for cleaning dishware. The composition is commercially positioned for manual-washing of dishware. Preferred compositions are in the form of a liquid.

As used herein the term “enhanced suds boosting” means a higher volume of suds is generated upon the dissolution of the detergent composition in a washing solution for a composition comprising a plant derived protein or blend of plant derived proteins and a specific surfactant system of the present invention, as compared with the suds longevity provided by the same composition and process in the absence of the plant derived protein or blend of plant derived proteins and the specific surfactant system of the present invention.

As used herein the term “increased suds longevity” means an increase in the duration of visible suds in a washing process for cleaning soiled dishware in this case when using the composition comprising a plant derived protein or blend of plant derived proteins and a specific surfactant system of the present invention, as compared with the suds longevity provided by the same composition and process in the absence of the plant derived protein or blend of plant derived proteins and the specific surfactant system of the present invention.

As used herein the term “protein isolate” means a protein that has been isolated from a plant source based on well-known extraction processes to those skilled in the art, such as for example alkali extraction and acid preparation, protein micellation method (PMM), or low pH extraction combined with protein isolate preparation (Wanadundara et al., OCL 2016, 23(4) D407). Depending on the method of protein extraction employed, the final product could vary in terms of the protein content, type and extent of interaction with non-protein components. Isolates are more pure than other forms (e.g., concentrates) as other non-protein components have been removed to “isolate” the protein of interest. Preferably, the protein isolate has a protein content (as determined by Kjeldahl Nx6.25) of at least about 80 wt % or more, preferably about 90 wt % or more, more preferably 100%, is substantially undenatured (as determined by differential scanning calorimetry) and has a low residual fat content of less than about 1 wt %.

As used herein the term “protomer” means the structural unit of an oligomeric protein. It is the smallest unit composed of at least two different protein chains that form a larger heterooligomer by association of two or more copies of this unit.

As used herein the term “subunit” means a single protein molecule that assembles (or “co-assembles”) with other protein molecules to form a protein complex.

As used herein the term “sudsing profile” refers to the properties of a detergent composition relating to suds character during the dishwashing process. For example, the sudsing profile of a detergent composition includes but is not limited to the suds generation upon dissolving of the detergent composition, and the volume and retention of the suds during the dishwashing process.

It is understood that the test methods that are disclosed in the Test Methods Section of the present application must be used to determine the respective values of the parameters of Applicants' inventions as described and claimed herein.

In all embodiments of the present invention, all percentages are by weight of the total composition, as evident by the context, unless specifically stated otherwise. All ratios are weight ratios, unless specifically stated otherwise, and all measurements are made at 25° C., unless otherwise designated.

### Detergent Composition

The inventors have surprisingly discovered a new way of formulating a detergent composition to provide good sudsing profile, particularly increased suds longevity, preferably in the presence of greasy soils. Essentially, the solution is to formulate a specific surfactant system which synergizes with a plant derived protein or blend of plant derived proteins derived from a Leguminous plant family In fact, the inventors have discovered that when the specific surfactant system is co-formulated with the plant derived protein or blend of plant derived proteins according to the invention, increased suds longevity, especially in the presence of greasy soil, is obtained. This enhanced sudsing is not observed with close surfactant systems outside the scope of the invention (see examples section). While not wishing to be bound by theory, it is believed that the specific surfactant system containing the plant derived protein or blend ofplant derived proteins may more easily go to the air-water interface and remain in the suds film lamellae due to its specific physical properties. As a result, the longevity of the suds is increased due to the plant derived protein-plant derived protein interactions that form strong continuous interfacial membrane that stabilizes the suds particles at the air-water interface.

In addition, the inventors have discovered that the plant derived protein or blend of plant derived proteins and surfactant system in the detergent composition also provides enhanced suds boosting benefit. Preferably, the detergent composition of the invention also provides good grease removal, in particular good uncooked grease removal.

The detergent composition of the present invention is a manual dishwashing composition, preferably in liquid form. It typically contains from about 30 wt % to about 95 wt %, preferably from about 40 wt % to about 90 wt %, more preferably from about 50 wt % to about 85 wt % by weight of the composition of a liquid carrier in which the other essential and optional components are dissolved, dispersed or suspended. One preferred component of the liquid carrier is water.

Preferably, the detergent composition of the present invention comprises a phytic acid content of about 0.5 wt % or less, preferably about 0.2 wt % or less, preferably about 0.1 wt % or less, preferably about 0.01 wt % or less by weight of the composition, most preferably the composition is essentially free, preferably free, of the phytic acid. Leguminous plant seed meals, including Pea, Chickpea, Lentil and Bean, contain phytic acid. Phytic acid (i.e., myo-inositol 1,2,3,4,5,6-hexakis (dihydrogen phosphate)) is a form of phosphorus (P) in seeds which is stored in the form of phytate salts. The term “phytic acid” as used herein includes such phytate salt forms. Depending on the Leguminous plant type, the content of phytic acid may range from about 0.3 wt % to about 10 wt %. Extraction of the Leguminous plant seed meals results in the presence of phytic acid in the protein isolate recovered. Phytic acid has a negative impact on the protein isolates, specifically, the presence of phytic acid reduces the protein solubility and/or flexibility thereby preventing its absorption at the air-water interface. As the quantity of phytic acid in the protein isolate increases, the negative impact of the protein performance increases. Thus, it is desirable to incorporate Pulse protein isolates that have substantially reduced or are essentially free of phytic acid. Reduced amounts of phytic acid content in the protein isolates from extraction of the seed meal may be achieved by extraction at temperatures above 50° C., in the presence of CaCl₂ or MgCl₂, and/or in the presence of from about 0.01% to about 1% phytase. Following these actions, the precipitated phytate can be removed from the protein solution such as by centrifugation.

The detergent composition of the present invention preferably comprises a protein-bound carbohydrate content of about 2 wt % or less, preferably about 1 wt % or less, preferably about 0.5 wt % or less, preferably about 0.1 wt % or less, preferably about 0.01 wt % or less by weight of the composition, most preferably the composition is essentially free, preferably free, of the protein-bound carbohydrate. The term “protein-bound carbohydrate” as used herein means an isolated protein that has carbohydrate bound (chemically or physically) to it. Carbohydrate bound proteins have decrease performance because the carbohydrate screen the active sites of the protein and reduces the protein solubility, flexibility and/or mobility thereby preventing its absorption at the air-water interface. Therefore, it is desirable to limit the level of isolated proteins that are bound to carbohydrates in the detergent composition. Reduced amounts of protein-bound carbohydrates in the protein isolates from extraction of the seed meal may be achieved by extraction with from about 0.01% to about 1% of a carbohydrate hydrolyzing enzyme, preferably carbohydrase. The carbohydrate residues can then be separated from the protein isolate fractions such as by membrane or dialysis filtration.

Preferably the pH of the detergent composition, measured as a 10% product concentration (i.e., dilution) in distilled water at 20° C., is adjusted to between about 6 and about 14, more preferably between about 7 and about 12, more preferably between about 7.5 and about 10. The pH of the composition can be adjusted using pH modifying ingredients known in the art.

The composition of the present invention can be Newtonian or non-Newtonian, preferably Newtonian. The composition has a viscosity of from about 10 to about 10,000 mPa·s, preferably from about 100 to about 5,000 mPa·s, more preferably from about 300 to about 2,000 mPa·s, or most preferably from about 500 to about 1,500 mPa·s. Viscosity is measured with a Brookfield DV-II+ Pro Viscometer using spindle 31 at 12 RPM at 20° C.

### Plant Derived Protein

The plant derived protein or blend of plant derived proteins are derived from a Leguminous plant family. The Leguminous plant family is selected from the group consisting of Fabaceae (or Leguminosae), preferably Vicia faba, Vigna aconitifolia, Vigna angularis, Vigna mungo, Vigna radiata, Vigna subterranea, Vigna umbellata, Vigna unguiculata, Psophocarpus tetragonolobus, Phaseolus acutifolius, Phaseolus coccineus, Phaseolus lunatus, Phaseolus polyanthus, Phaseolus vulgaris Canavalia gladiata, Canavalia ensiformis, Lupinus mutabilis, Lupinus albus, Cicer arietinum, Lens culinaris and Pisum savitum, preferably Vicia faba, Cicer arietinum, Lens culinaris, and Pisum savitum. Preferably, the Leguminous plant protein is a Pulse protein, more preferably the Pulse protein is selected from the group consisting of a Pea protein, a Chickpea protein, a Lentil protein, a Bean protein, and mixtures thereof, most preferably the Pulse protein is a Pea protein.

Pulse proteins are an important source of food proteins, and possess functional properties including foaming that have been exploited for use in the formulation and development of food products such as bakery products, soups, and snacks. Typically, Pulse proteins contain protein components/fractions that are known as storage proteins that can be classified into four groups: Albumins, Globulins, Prolamins, and Glutelines. Globulins and Albumins are the two predominant storage proteins found in Pulse proteins. The storage proteins from different plants (e.g., Pea, Chickpea, Lentil, Bean) can be classified by their sedimentation coefficient in Svedberg units (S). This coefficient indicates the speed of sedimentation of a macromolecule in a centrifugal field. It should be noted however that some small variations of sedimentations are expected depending on the type of Leguminous plant and/or the extraction protocol employed. Therefore, the sedimentation coefficient is not intended to be restrictive, but rather serve as a useful guide for the classification of the storage proteins.

Globulins represent 65%-80% of the Pulse proteins. The major Globulins found in Pulse proteins are Vicilin (7S) and Legumin (11S). The Vicilin (7S) has a trimeric structure with molecular mass (MM) of ˜175-180 kDa and lacks disulfide bridging. In contrast, the Legumin (11S) has a hexameric (MM of ˜340-360 kDa) quaternary structure composed of 6 subunits (MM of ˜60 kDa) linked by non-covalent interactions. Each subunit pair is comprised of an acidic (MM ˜40 kDa) and basic (MM ˜20 kDa) chain joined by a disulfide bond. The ratio of the Legumin:vicilin (L/V) is not fixed and may vary among different Pulse varieties and species. There is a third Globulin Pulse protein called Convicilin with its 3 or 4 subunits each having a MM of ˜70 kDa and a sedimentation coefficient of ˜8S. Convicilin is present in lesser amounts as compared to other Globulins. Albumins represent about 20% of the Pulse proteins. The Albumins found in Pulse proteins are soluble proteins with a variable MM (˜12-28 kDa).

The Pulse proteins are capable of foaming, dispersing, gelling, and/or emulsifying. Depending on the type(s) of Pulse proteins selected and/or the levels/mixture of the Globulins:Albumins, the properties of the resulting Pulse proteins composition can be different. Preferably, the Pulse proteins can be selectively adjusted, for example by the choice of the extraction methods and/or parameters of the extraction, particularly for the purpose of optimizing their foaming properties.

The inventors have surprisingly discovered that by formulating with Leguminous plant proteins, preferably Pulse proteins, together with a specific surfactant system, it is possible to obtain a good sudsing profile, in particular enhanced suds boosting and/or increased suds longevity, especially in the presence of greasy soils. Use of protein isolates that target protein in highly pure form eliminates most of the undesirable interference from non-protein components. Therefore, it is preferred that the Leguminous plant proteins of the present invention are used in the form of Leguminous plant protein isolates. Preferably, the protein isolates have been extracted by protein micellization process and/or ultra-filtration, optionally followed by re-blending of the separated protein isolate fractions to achieve the desired ratio of the Globulins to Albumins to maximize sudsing performance.

Pea Protein

There are multiple varieties of Pea. The protein content for the different varieties range from 23-31%. The major Pea proteins are constituted of Globulins and Albumins, which range from ˜15-25% of Pea Albumins and 50-60% of the Pea Globulins based on the total Pea protein level. Heterogeneity in the protein composition of different Pea varieties as well as in the polypeptide composition of individual proteins from a single Pea variety has been reported (Gueguen, et al., J. Science of Food and Agriculture, 35 (1984), pp. 1024-1033). The Pea proteins can be divided into various fractions according to the corresponding sedimentation coefficient. For Pea proteins, the main reported fractions are: 7S and 11S, which correspond to Pea Vicilin (7S) and Pea Legumin (11S) respectively. Pea Vicilin, the 7S Pea protein, has a trimeric structure each subunit having a MM of ˜50 kDa. Pea Vicilin can be cleaved at one or two sites (called the α-β and β-γ processing sites). Cleavage at the α-β site generates fragments of 19 kDa and 30 kDa, whereas cleavage at the β-γ site generate fragments of 12.5 kDa or 16 kDa and 33 kDa. Cleavage at both sites generates fragments of 12.5 kDa, 13.5 kDa and 16 kDa or 19 kDa. As a result, there is extensive polypeptide heterogeneity of Pea Vicilin.

Pea Legumin comprises six subunits with a MM of ˜60 kDa. Each subunit is proteolytically cleaved into disulfide-linked basic and acidic polypeptides, with the size of the Pea polypeptides ranging from ˜38-40 kDa for the acidic ones and ˜19-22 kDa for the basic Pea polypeptides. These Pea Legumin polypeptides display charge and size heterogeneity, reflecting the possible production of varieties of the Pea Legumin. Other fractions of the Pea proteins include: 2S, 8S, and 15S, of which the 8S fraction corresponds to Pea Convicilin respectively. Pea Convicilin, the 8S Pea protein, has a trimeric structure each subunit having a MM of ˜70 kDa. Pea Convicilin has an extensive homology with Pea Vicilin along the core of its protein, but holds an additional highly charged, hydrophilic sequence of 120-166 residues close to the polypeptide N-terminus.

Previous use of Pea protein isolates has reported good foaming properties, however, the Pea protein isolates must be concentrated in order to be more viscous to mediate its effect (para. [0045], US2008/0226810). Inventors have surprisingly overcome the need to concentrate the Pea protein isolates which can be achieved by co-formulating the Chickpea protein isolates with the specific surfactant system of the invention to provide good sudsing profile particularly increased suds longevity, especially in the presence of greasy soils.

Preferably, the composition of the present invention comprises a Pea protein which is a Pea protein isolate comprising the predominate storage proteins of Pea Albumin and Pea Globulin preferably selected from Pea Legumin (11S), Pea Vicilin (7S) and/or Pea Convicilin (8S), or mixtures thereof.

Preferably, the composition of the present invention may comprise a Pea protein which is a Pea protein isolate comprising:
i) a first Pea protein isolate component comprising a Pea Albumin protein, preferably from about 20 wt % to about 95 wt %, more preferably from about 50 wt % to about 95 wt %, by weight of the total Pea protein level in the composition;
ii) a second Pea protein isolate component comprising a Pea Vicilin protein and/or a Pea Convicilin protein, preferably from about 5 wt % to about 80 wt %, more preferably from about 5 wt % to about 50 wt %, by weight of the total Pea protein level in the composition; and
iii) a third Pea protein isolate component comprising a Pea Legumin protein, preferably from 0 wt % to about 30 wt %, more preferably 0 wt %, by weight of the total Pea protein level in the composition.

Preferably, the Pea protein isolate is obtained by extraction from a Pea seed meal according to a process as disclosed for example in US Publication No. US2008/0226810, and PCT Publications Nos. WO2016/15151 and WO2014/190418. Alternatively, the Pea protein isolate is commercially available as Nutralys® pea protein from Roquette Freres (France) or Pea Protein Isolate from MyProtein (United Kingdom).

There are two Pea Albumin proteins (PA1 and PA2). The major Pea Albumin protein contains two polypeptides with a MM of ˜22-26 kDa, whereas the minor Pea Albumin protein is a low MM protein containing polypeptides with MM of ˜6 kDa. Specifically, the Pea Albumin proteins are proposed for use in applications for suds generation. Without wishing to be bound by theory, it is believed that the Pea Albumin functions for suds generation because it has small molecular mass and high flexibility that allows for fast absorption at the air-water interface. Pea Globulins are the major storage protein in the Pea and are comprised of the Pea Legumins (11S), Pea Vicilins (7S) and/or Pea Convicilins (8S). Preferably, the Pea Globulins comprise of Pea Vicilins (7S), Pea Legumins (11S) and mixtures thereof, preferably present at a ratio of Pea Vicilins (7S): Pea Legumins (11S): of 0.5 to 1.7. Specifically, the Pea Globulins are proposed for use in applications for suds stabilization. It is believed that the Pea Globulins functions for suds stability because it has large molecular mass and can form protein-protein and protein-surfactant network at the air-water interface. Therefore, it is highly preferable for a composition of the present invention to include a blend of vegetable proteins, preferably Pulse proteins, comprising a Pea Albumin, a Pea Globulin, or mixtures thereof, in order to enhance suds boosting and/or increase suds longevity benefits, especially in the presence of greasy soils.

Preferably, the detergent composition of the present invention comprises a Pea protein which has at least 50%, preferably at least 60%, preferably at least 70%, preferably at least 80%, preferably at least 85%, preferably at least 90%, preferably at least 95%, preferably at least 98% or even 100% amino acid identity to a Pea Legumin protein (SEQ ID NOs: 1-8), a Pea Vicilin protein or a Pea Convicilin protein (SEQ ID NOs: 9-24), or a Pea Albumin protein (SEQ ID NOs: 25-31).

Chickpea Protein

The term “Chickpea”, also known as bengal gram, garbanzo bean, or gram, refers to any type of the species Cicer arietinum. Preferable species of Chickpeas are the two major types: Kabuli and Desi. Protein content of the Chickpea varieties range from ˜20-26%. Chickpea Globulins represent the largest fraction (>50%) followed by Chickpea Albumins (>15%) based on the total Chickpea protein content. Preferably, the composition of the present invention comprises a Chickpea protein which is a Chickpea protein isolate (CPI) comprising the two predominant storage proteins which are a Chickpea Albumin, a Chickpea Globulin, or mixtures thereof. Preferably, the Chickpea protein isolate is obtained by extraction from a Chickpea source, preferably defatted Chickpea flour, according to the process as disclosed, for example, in Papalamprou et al., J. Science of Food and Agriculture, 90(2); 304-313, and PCT Publications Nos. WO2016/15151 and WO2014/190418. Alternatively, the Chickpea protein isolate can be extracted from commercially available protein concentrate as ProEarth® from Cambridge Commodities Ltd. (United Kingdom).

Previous use of Chickpea protein isolates has reported that they have low foaming capability and the foams generated with Chickpea protein isolates have low stability (Food Research Int., 52 (2013); 445-451). Inventors have surprisingly overcome these issues by co-formulating the Chickpea protein isolates with the specific surfactant system of the invention to provide good sudsing profile, particularly increased suds longevity, especially in the presence of greasy soils. Without wishing to be bound by theory, it is believed that the Chickpea Globulins and Chickpea Albumins provide the same function for suds generation and/or stabilization as described above for the Pea protein.

Preferably, the composition of the present invention may comprise a Chickpea protein which is a Chickpea protein isolate comprising:
i) a first Chickpea protein isolate component comprising a Chickpea Albumin protein, preferably from about 20 wt % to about 95 wt %, more preferably from about 50 wt % to about 95 wt %, by weight of the total Chickpea protein level in the composition; and
ii) a second Chickpea protein isolate component comprising a Chickpea Globulin protein preferably Chickpea Legumin protein, Chickpea Vicilin protein and/or Chickpea Convicilin protein, preferably from about 5 wt % to about 80 wt %, more preferably from about 5 wt % to about 50 wt %, by weight of the total Chickpea protein level in the composition.

Preferably, the detergent composition of the present invention comprises a Chickpea protein which has at least 50%, preferably at least 60%, preferably at least 70%, preferably at least 80%, preferably at least 85%, preferably at least 90%, preferably at least 95%, preferably at least 98% or even 100% amino acid identity to a Chickpea Legumin protein (SEQ ID NOs: 50-56), a Chickpea Vicilin protein or a Chickpea Convicilin protein (SEQ ID NOs: 57-70), or a Chickpea Albumin protein (SEQ ID NOs: 71-76).

Lentil Protein

Lentil (Lens culinaris), also known as Lens esculenta, is an edible Pulse. It's a member of the Legume family Fabaceae, known for its lens-shaped seeds. Like other Legume proteins, the Lentil varieties are rich in protein (˜22-31%). Lentil Globulins represent the largest fraction at >50% of the total Lentil protein content, followed by Lentil Albumins at >15% of the total Lentil protein content. Lentil Globulins are composed of two major proteins—Lentil Legumin (11S) and Vicilin (7S) proteins. Lentil Globulins may also encompass Lentil Convicilin protein.

Preferably, the Lentil protein isolate is obtained by extraction from a Lentil source according to a process as disclosed, such as for example, Swanson, J. Amer. Oil Chemists' Society, Vol. 67(5) (1990); 276-280, and PCT Publication No. WO2016/062567. Alternatively, the Lentil protein can be extracted from commercially lentil flour available from Ingredion (Illinois, USA) or Archer Daniels Midland (Illinois, USA).

Lentil protein isolates and starch (particularly gelatinized starch) have been used in food products as foaming agents and can provide considerable foam stability, particularly associated with the Lentil Albumin (see WO2016/062567). Preferably, the compositions of the present invention comprise a Lentil protein isolate and are essentially free, preferably free, of a Lentil starch. The term “Lentil starch” as used herein refers to a native, unmodified starch derived form a Lentil source. Lentil starch consists of two types of molecules: the linear and helical amylose and the branched amylopectin.

Preferably, the composition of the present invention may comprise a Lentil protein which is a Lentil protein isolate comprising
i) a first Lentil protein isolate component comprising a Lentil Albumin protein, preferably from about 20 wt % to about 95 wt %, more preferably from about 50 wt % to about 95 wt %, by weight of the total Lentil protein level in the composition;
ii) a second Lentil protein isolate component comprising a Lentil Globulin protein preferably Lentil Legumin protein, Lentil Vicilin protein and/or Lentil Convicilin protein, preferably from about 5 wt % to about 80 wt %, more preferably from about 5 wt % to about 50 wt %, by weight of the total Lentil protein level in the composition.

Preferably, the detergent composition of the present invention comprises a Lentil protein which has at least 50%, preferably at least 60%, preferably at least 70%, preferably at least 80%, preferably at least 85%, preferably at least 90%, preferably at least 95%, preferably at least 98% or even 100% amino acid identity to a Lentil Vicilin protein or a Lentil Convicilin protein (SEQ ID NOs: 77-80).

Bean Protein

The Bean (Phaseolus vulgaris L.), also known as common bean or great northern bean, is an edible dry seed. The protein content of Bean varieties varies from ˜18-24%. Bean Globulins represent the largest fraction at ˜80% of the total Bean protein content, followed by Bean Albumins at >5% of the total Bean protein content. Bean Globulins are composed of two major proteins—Bean Vicilin (7S), which can also be refer to as phaseolin, and Bean Legumin (11S) proteins. Bean Globulins may also encompass Bean Convicilin protein.

Preferably, the Bean protein isolate is obtained by extraction from a Bean source according to a process as disclosed, such as for example, PCT Publication Nos. WO2016/01515A1, WO2014/190418, and WO2014/053052. Alternatively, the Bean protein can be extracted from commercially available protein concentrated as Vitessence™ from Ingredion (Illinois, USA).

The foaming ability and stability of the Bean protein has been reported as fair. Furthermore, the foamability of the Bean protein is concentration dependent (Sathe, et al., J. Food Science, (1981), Vol. 46(1), 71-81). Inventors have surprisingly overcome these issues by co-formulating the Bean protein isolates with the specific surfactant system of the invention to provide good sudsing profile, particularly increased suds longevity, especially in the presence of greasy soils. Without wishing to be bound by theory, it is believed that the Bean Globulins and Bean Albumins provide the same function for suds generation and/or stabilization as described above for the Pea protein.

Preferably, the composition of the present invention may comprise a Bean protein which is a Bean protein isolate comprising:
i) a first Bean protein isolate component comprising a Bean Albumin protein, preferably from about 10 wt % to about 90 wt %, more preferably from about 50 wt % to about 90 wt %, by weight of the total Bean protein level in the composition;
ii) a second Bean protein isolate component comprising a Bean Vicilin protein and/or a Bean Convicilin protein, preferably from about 5 wt % to about 85 wt %, more preferably from about 5 wt % to about 50 wt %, by weight of the total Bean protein level in the composition; and
iii) a third Bean protein isolate component comprising a Bean Legumin protein, preferably from about 5 wt % to about 85 wt %, more preferably from about 5 wt % to about 50 wt %, by weight of the total Bean protein level in the composition.

The Bean Globulin and Bean Albumin provides the same function for suds generation and stabilization as described above for the Pea protein. Preferably, the detergent composition of the present invention comprises a Bean protein which has at least 50%, preferably at least 60%, preferably at least 70%, preferably at least 80%, preferably at least 85%, preferably at least 90%, preferably at least 95%, preferably at least 98% or even 100% amino acid identity to a Bean Legumin protein (SEQ ID NOs: 32-36), a Bean Vicilin protein or a Bean Convicilin protein (SEQ ID NOs: 37-39), or a Bean Albumin protein (SEQ ID NOs: 40-49).

Preferably, the plant derived protein or blend of plant derived proteins, preferably a Pulse protein, comprise a subunit or a protomer of a Globulin, preferably the subunit or the protomer has a molecular weight ranging from 30 kDa to 80 kDa and comprises from 1% to 80% of the total plant derived protein load in the composition.

Preferably, the subunit or the protomer of the Globulin has at least 50%, preferably at least 60%, preferably at least 70%, preferably at least 80%, preferably at least 85%, preferably at least 90%, preferably at least 95%, preferably at least 98% or even 100% amino acid identity to SEQ ID NOs: 1-24, 32-39, 50-70, or 77-80.

Identity, or homology, percentages as mentioned herein in respect of the present invention are those that can be calculated with the GAP program, obtainable from GCG (Genetics Computer Group Inc., Madison, Wis., USA). Alternatively, a manual alignment can be performed.

### Surfactant System

The detergent composition of the present invention comprises a surfactant system. Preferably the detergent composition comprises from about 1 wt % to about 60 wt %, preferably from about 5 wt % to about 50 wt %, more preferably from about 8 wt % to 40%, by weight of the total composition of a surfactant system.

The surfactant system of the composition of the present invention comprises an anionic surfactant. Preferably, the surfactant system for the detergent composition of the present invention comprises from about 50 wt % to about 85 wt %, preferably from about 55 wt % to about 80 wt %, more preferably from about 60 wt % to about 75 wt % by weight of the surfactant system of an anionic surfactant. The anionic surfactant can be any anionic cleaning surfactant, preferably selected from sulfate and/or sulfonate anionic surfactants. HLAS (linear alkylbenzene sulfonate) would be the most preferred sulfonate anionic surfactant. Especially preferred anionic surfactant is selected from the group consisting of alkyl sulfate, alkyl alkoxy sulfate and mixtures thereof, and preferably wherein the alkyl alkoxy sulfate is an alkyl ethoxy sulfate. Preferred anionic surfactant is an alkyl ethoxy sulfate with an average ethoxylation degree of less than about 5, preferably less than about 3, more preferably less than about 2 and more than about 0.5 and preferably wherein the alkyl ethoxy sulfate has an average alkyl carbon chain length of from about 8 to about 16, preferably from about 12 to about 15, more preferably from about 12 to about 14. Preferably, the alkyl ethoxy sulfate has an average level of branching of from about 5% to about 40%, more preferably from about 10% to about 35%, and even more preferably from about 20% to about 30%.

The average alkoxylation degree is the mol average alkoxylation degree of all the components of the mixture (i.e., mol average alkoxylation degree) of the anionic surfactant. In the mol average alkoxylation degree calculation the weight of sulfate anionic surfactant components not having alkoxylate groups should also be included.

Mol average alkoxylation degree=(x1*alkoxylation degree of surfactant 1+x2*alkoxylation degree of surfactant 2+ . . . )/(x1+x2+ . . . )

wherein x1, x2, . . . are the number of moles of each sulfate anionic surfactant of the mixture and alkoxylation degree is the number of alkoxy groups in each sulfate anionic surfactant.

The average level of branching is the weight average % of branching and it is defined according to the following formula:

Weight average of branching (%)=[(x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material for the anionic surfactant for the composition of the invention. In the weight average branching degree calculation the weight of anionic surfactant components not having branched groups should also be included.

Suitable examples of commercially available sulfates include, those based on Neodol alcohols ex the Shell company, Lial-Isalchem and Safol ex the Sasol company, natural alcohols ex The Procter & Gamble Chemicals company. Suitable sulfonate surfactants for use herein include water-soluble salts of C8-C18 alkyl or hydroxyalkyl sulfonates; C11-C18 alkyl benzene sulfonates (LAS), modified alkylbenzene sulfonate (MLAS); methyl ester sulfonate (MES); and alpha-olefin sulfonate (AOS). Those also include the paraffin sulfonates may be monosulfonates and/or disulfonates, obtained by sulfonating paraffins of 10 to 20 carbon atoms. The sulfonate surfactant also include the alkyl glyceryl sulfonate surfactants.

Preferably the surfactant system for the detergent composition of the present invention will comprise from about 1 wt % to about 40 wt %, preferably from about 6 wt % to about 32 wt %, more preferably from about 8 wt % to about 25 wt % by weight of the total detergent composition of an anionic surfactant.

The surfactant system of the detergent composition of the present invention further comprises a primary co-surfactant system, wherein the primary co-surfactant system is preferably selected from the group consisting of amphoteric surfactant preferably amine oxide, zwitterionic surfactant preferably betaine, and mixtures thereof. Preferably, the surfactant system for the detergent composition of the present invention comprises from about 15 wt % to about 50 wt %, preferably from about 20 wt % to about 45 wt %, more preferably from about 25 wt % to about 40 wt %, by weight of the surfactant system of a primary co-surfactant system. Preferably the detergent composition comprises from about 0.01 wt % to about 20 wt %, preferably from about 0.2 wt % to about 15 wt %, more preferably from about 0.5 wt % to about 10 wt % by weight of the detergent composition of an amphoteric and/or a zwitterionic surfactant, more preferably an amphoteric surfactant, even more preferably an amine oxide surfactant.

Preferably the primary co-surfactant system is an amphoteric surfactant. Preferably, the primary co-surfactant system is an amine oxide surfactant selected from the group consisting of linear or branched alkyl amine oxide, linear or branched alkyl amidopropyl amine oxide, and mixtures thereof, preferably linear alkyl dimethyl amine oxide, more preferably linear C10 alkyl dimethyl amine oxide, linear C12-C14 alkyl dimethyl amine oxides and mixtures thereof, most preferably C12-C14 alkyl dimethyl amine oxide. Preferably, the composition comprises anionic surfactant and amine oxide surfactant in a ratio of less than about 9:1, more preferably from about 5:1 to about 1:1, more preferably from about 4:1 to about 2:1, preferably from about 3:1 to about 2.5:1. Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1−N(R2)(R3) O wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the α carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1-n2| is less than or equal to 5, preferably 4, most preferably from 0 to 4 carbon atoms in at least about 50 wt %, more preferably at least about 75 wt % to about 100 wt % of the mid-branched amine oxides for use herein. The amine oxide further comprises two moieties, independently selected from a C1-3 alkyl, a C1-3 hydroxyalkyl group, or a polyethylene oxide group containing an average of from about 1 to about 3 ethylene oxide groups. Preferably, the two moieties are selected from a C1-3 alkyl, more preferably both are selected as a C1 alkyl.

Preferably the amine oxide surfactant is a mixture of amine oxides comprising a low-cut amine oxide and a mid-cut amine oxide. The amine oxide of the composition of the invention then comprises:
a) from about 10% to about 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls or mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof

In a preferred low-cut amine oxide for use herein R3 is n-decyl. In another preferred low-cut amine oxide for use herein R1 and R2 are both methyl. In an especially preferred low-cut amine oxide for use herein R1 and R2 are both methyl and R3 is n-decyl.

Preferably, the amine oxide comprises less than about 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Compositions comprising R7R8R9AO tend to be unstable and do not provide very suds mileage.

Preferably the primary co-surfactant system is a zwitterionic surfactant. Suitable examples of zwitterionic surfactants include betaines, such as alkyl betaines, alkylamidobetaine, amidazoliniumbetaine, sulfobetaine (INCI Sultaines) as well as the Phosphobetaine and preferably meets formula (I):

R1-[CO—X (CH2)n]x-N+(R2)(R3)-(CH2)m-[CH(OH)—CH2]y-Y— (I)

wherein:
R1 is a saturated or unsaturated C6-22 alkyl residue, preferably C8-18 alkyl residue, in particular a saturated C10-16 alkyl residue, for example a saturated C12-14 alkyl residue;
X is NH, NR4 with C1-4 Alkyl residue R4, O or S;
n is a number from 1 to 10, preferably 2 to 5, in particular 3;
x is 0 or 1, preferably 1;
R2 and R3 are independently a C1-4 alkyl residue, potentially hydroxy substituted such as a hydroxyethyl, preferably a methyl;
m is a number from 1 to 4, in particular 1, 2 or 3;
y is 0 or 1; and
Y is COO, SO3, OPO(OR5)O or P(O)(OR5)O, whereby R5 is a hydrogen atom H or a C1-4 alkyl residue.

Preferred betaines are the alkyl betaines of the formula (Ia), the alkyl amido propyl betaine of the formula (Ib), the Sulfo betaines of the formula (Ic), and the Amido sulfobetaine of the formula (Id);

R1-N+(CH3)2-CH2COO— (Ia)

R1-CO—NH(CH2)3-N+(CH3)2-CH2COO— (Ib)

R1-N+(CH3)2-CH2CH(OH)CH2SO3- (Ic)

R1-CO—NH—(CH2)3-N+(CH3)2-CH2CH(OH)CH2SO3- (Id)

in which R1 has the same meaning as in formula I. Particularly preferred betaines are the Carbobetaine [wherein Y—═COO—], in particular the Carbobetaine of the formula (Ia) and (Ib), more preferred are the Alkylamidobetaine of the formula (Ib).

Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines. A preferred betaine is, for example, Cocoamidopropylbetaine.

Preferably, the surfactant system of the composition of the present invention further comprises from about 1 wt % to about 25 wt %, preferably from about 1.25 wt % to about 20 wt %, more preferably from about 1.5 wt % to about 15 wt %, most preferably from about 1.5 wt % to about 5 wt %, by weight of the surfactant system of a secondary co-surfactant system preferably comprising a non-ionic surfactant. Preferably the non-ionic surfactant is an alkyl ethoxylated non-ionic surfactant, preferably comprising on average from about 9 to about 15 preferably from about 10 to about 14 carbon atoms in its alkyl chain and on average from about 5 to about 12, preferably from about 6 to about 10, most preferably from about 7 to about 8, units of ethylene oxide per mole of alcohol.

Suitable non-ionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol. Highly preferred non-ionic surfactants are the condensation products of guerbet alcohols with from 2 to 18 moles, preferably 2 to 15, more preferably 5-12 of ethylene oxide per mole of alcohol. Preferably, the non-ionic surfactants are an alkyl ethoxylated surfactants, preferably comprising from 9 to 15 carbon atoms in its alkyl chain and from 5 to 12 units of ethylene oxide per mole of alcohol. Other suitable non-ionic surfactants for use herein include fatty alcohol polyglycol ethers, alkylpolyglucosides and fatty acid glucamides, preferably alkylpolyglucosides. Preferably the alkyl polyglucoside surfactant is a C8-C16 alkyl polyglucoside surfactant, preferably a C8-C14 alkyl polyglucoside surfactant, preferably with an average degree of polymerization of between 0.1 and 3, more preferably between 0.5 and 2.5, even more preferably between 1 and 2. Most preferably the alkyl polyglucoside surfactant has an average alkyl carbon chain length between 10 and 16, preferably between 10 and 14, most preferably between 12 and 14, with an average degree of polymerization of between 0.5 and 2.5 preferably between 1 and 2, most preferably between 1.2 and 1.6. C8-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation). Preferably, the composition comprises the anionic surfactant and the non-ionic surfactant in a ratio of from 2:1 to 50:1, preferably 2:1 to 10:1. Preferably the non-ionic surfactant is present from about 0.01 wt % to about 20 wt %, preferably from about 0.2 wt % to about 15 wt %, more preferably from about 0.5 wt % to about 10 wt % by weight of the total detergent composition.

### Salt:

The composition of the present invention may optionally comprise from about 0.01% to about 3%, preferably from about 0.05% to about 2%, more preferably from about 0.2% to about 1.5%, or most preferably from about 0.5% to about 1%, by weight of the total composition of a salt, preferably a monovalent, divalent inorganic salt or a mixture thereof, preferably the divalent inorganic salt is chloride and/or sulfate salt of magnesium, calcium or zinc, most preferably magnesium chloride, sodium chloride or mixtures thereof. The composition alternatively or further comprises a multivalent metal cation in the amount of from about 0.01 wt % to about 2 wt %, preferably from about 0.1% to about 1%, more preferably from about 0.2% to about 0.8% by weight of the composition, preferably the multivalent metal cation is magnesium, aluminium, copper, calcium or iron, more preferably magnesium, most preferably said multivalent salt is magnesium chloride. Without wishing to be bound by theory, it is believed that use of a multivalent cation helps with the formation of protein/protein, surfactant/surfactant or hybrid protein/surfactant network at the oil water and air water interface that is strengthening the suds.

### Carbohydrates

Preferably the composition of the present invention comprises one or more carbohydrates selected from the group comprising O-glycan, N-glycan, and mixtures thereof. Suitable carbohydrates include alpha or beta glucan with 1.3 and/or 1.4 and/or 1.6 linkage. Glucans can be modified especially with carboxyl sulfate, glycol ether of amino groups. Glucan can be extracted from dextran. Glucan with structure close to natural glucan such as schizophyllan, scleroglucan or paramylon are particularly preferred. Preferably the composition comprises from about 0.005% to about 1% of the carbohydrates.

### Hydrotrope

The composition of the present invention may optionally comprise from about 1% to about 10%, or preferably from about 0.5% to about 10%, more preferably from about 1% to about 6%, or most preferably from about 0.1% to about 3%, or combinations thereof, by weight of the total composition of a hydrotrope, preferably sodium cumene sulfonate. Other suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, as disclosed in U.S. Pat. No. 3,915,903. Preferably the composition of the present invention is isotropic. An isotropic composition is distinguished from oil-in-water emulsions and lamellar phase compositions. Polarized light microscopy can assess whether the composition is isotropic. See e.g., The Aqueous Phase Behaviour of Surfactants, Robert Laughlin, Academic Press, 1994, pp. 538-542. Preferably an isotropic composition is provided. Preferably the composition comprises 0.1% to 3% by weight of the total composition of a hydrotrope, preferably wherein the hydrotrope is selected from sodium, potassium, and ammonium xylene sulfonate, sodium, potassium and ammonium toluene sulfonate, sodium potassium and ammonium cumene sulfonate, and mixtures thereof.

### Organic Solvent

The composition of the present invention may optionally comprise an organic solvent. Suitable organic solvents include C4-14 ethers and diethers, polyols, glycols, alkoxylated glycols, C6-C16 glycol ethers, alkoxylated aromatic alcohols, aromatic alcohols, aliphatic linear or branched alcohols, alkoxylated aliphatic linear or branched alcohols, alkoxylated C1-C5 alcohols, C8-C14 alkyl and cycloalkyl hydrocarbons and halohydrocarbons, and mixtures thereof. Preferably the organic solvents include alcohols, glycols, and glycol ethers, alternatively alcohols and glycols. The composition comprises from 0% to less than about 50%, preferably from about 0.01% to about 25%, more preferably from about 0.1% to about 10%, or most preferably from about 0.5% to about 5%, by weight of the total composition of an organic solvent, preferably an alcohol, more preferably an ethanol, a polyalkyleneglycol, more preferably polypropyleneglycol, and mixtures thereof.

### Amphiphilic Polymer

The composition of the present invention may further comprise from about 0.01% to about 5%, preferably from about 0.05% to about 2%, more preferably from about 0.07% to about 1% by weight of the total composition of an amphiphilic polymer selected from the groups consisting of amphiphilic alkoxylated polyalkyleneimine and mixtures thereof, preferably an amphiphilic alkoxylated polyalkyleneimine

Preferably, the amphiphilic alkoxylated polyalkyleneimine is an alkoxylated polyethyleneimine polymer comprising a polyethyleneimine backbone having average molecular weight range from about 100 to about 5,000, preferably from about 400 to about 2,000, more preferably from about 400 to about 1,000 Daltons and the alkoxylated polyethyleneimine polymer further comprising:
(i) one or two alkoxylation modifications per nitrogen atom by a polyalkoxylene chain having an average of about 1 to about 50 alkoxy moieties per modification, wherein the terminal alkoxy moiety of the alkoxylation modification is capped with hydrogen, a C1-C4 alkyl or mixtures thereof;
(ii) an addition of one C1-C4 alkyl moiety and one or two alkoxylation modifications per nitrogen atom by a polyalkoxylene chain having an average of about 1 to about 50 alkoxy moieties per modification wherein the terminal alkoxy moiety is capped with hydrogen, a C1-C4 alkyl or mixtures thereof; or
(iii)a combination thereof; and

wherein the alkoxy moieties comprises ethoxy (EO) and/or propxy (PO) and/or butoxy (BO) and wherein when the alkoxylation modification comprises EO it also comprises PO or BO.

Preferred amphiphilic alkoxylated polyethyleneimine polymers comprise EO and PO groups within their alkoxylation chains, the PO groups preferably being in terminal position of the alkoxy chains, and the alkoxylation chains preferably being hydrogen capped. Hydrophilic alkoxylated polyethyleneimine polymers solely comprising ethoxy (EO) units within the alkoxylation chain could also optionally be formulated within the scope of this invention.

For example, but not limited to, below is shown possible modifications to terminal nitrogen atoms in the polyethyleneimine backbone where R represents an ethylene spacer and E represents a C1-C4 alkyl moiety and X— represents a suitable water soluble counterion.

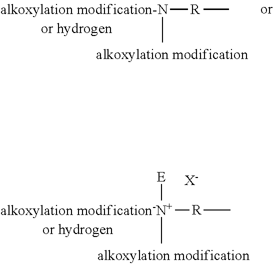

Also, for example, but not limited to, below is shown possible modifications to internal nitrogenatoms in the polyethyleneimine backbone where R represents an ethylene spacer and E represents a C₁-C₄ alkyl moiety and X— represents a suitable water soluble counterion.

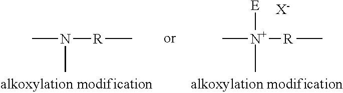

The alkoxylation modification of the polyethyleneimine backbone consists of the replacement of a hydrogen atom by a polyalkoxylene chain having an average of about 1 to about 50 alkoxy moieties, preferably from about 20 to about 45 alkoxy moieties, most preferably from about 30 to about 45 alkoxy moieties. The alkoxy moieties are selected from ethoxy (EO), propoxy (PO), butoxy (BO), and mixtures thereof. Alkoxy moieties solely comprising ethoxy units are outside the scope of the invention though. Preferably, the polyalkoxylene chain is selected from ethoxy/propoxy block moieties. More preferably, the polyalkoxylene chain is ethoxy/propoxy block moieties having an average degree of ethoxylation from about 3 to about 30 and an average degree of propoxylation from about 1 to about 20, more preferably ethoxy/propoxy block moieties having an average degree of ethoxylation from about 20 to about 30 and an average degree of propoxylation from about 10 to about 20.

More preferably the ethoxy/propoxy block moieties have a relative ethoxy to propoxy unit ratio between about 3 to about 1 and about 1 to about 1, preferably between about 2 to about 1 and about 1 to about 1. Most preferably the polyalkoxylene chain is the ethoxy/propoxy block moieties wherein the propoxy moiety block is the terminal alkoxy moiety block.

The modification may result in permanent quaternization of the polyethyleneimine backbone nitrogen atoms. The degree of permanent quaternization may be from 0% to about 30% of the polyethyleneimine backbone nitrogen atoms. It is preferred to have less than about 30% of the polyethyleneimine backbone nitrogen atoms permanently quaternized. Most preferably the degree of quaternization is about 0%.

A preferred polyethyleneimine has the general structure of Formula (II):

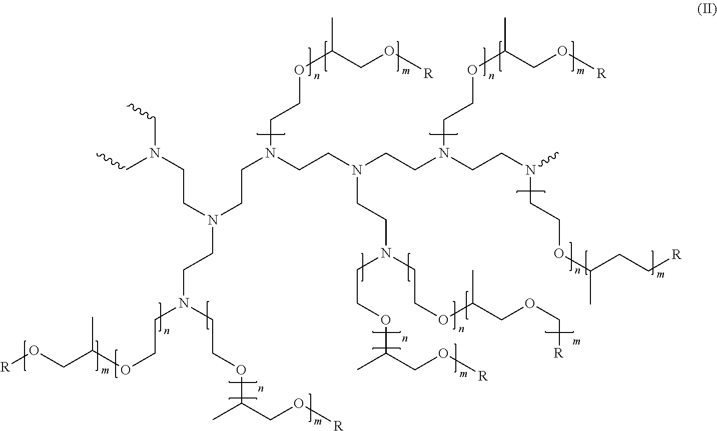

wherein the polyethyleneimine backbone has a weight average molecular weight of about 600, n of formula (II) has an average of about 10, m of formula (II) has an average of about 7 and R of formula (II) is selected from hydrogen, a C₁-C₄ alkyl and mixtures thereof, preferably hydrogen. The degree of permanent quaternization of formula (II) may be from 0% to about 22% of the polyethyleneimine backbone nitrogen atoms. The molecular weight of this polyethyleneimine preferably is between about 10,000 and about 15,000.

An alternative polyethyleneimine has the general structure of Formula (II) but wherein the polyethyleneimine backbone has a weight average molecular weight of about 600, n of Formula (II) has an average of about 24, m of Formula (II) has an average of about 16 and R of Formula (II) is selected from hydrogen, a C₁-C₄ alkyl and mixtures thereof, preferably hydrogen. The degree of permanent quaternization of Formula (II) may be from 0% to about 22% of the polyethyleneimine backbone nitrogen atoms. The molecular weight of this polyethyleneimine preferably is between about 25,000 and about 30,000.

Most preferred polyethyleneimine has the general structure of Formula (II) wherein the polyethyleneimine backbone has a weight average molecular weight of about 600, n of Formula (II) has an average of about 24, m of Formula (II) has an average of about 16 and R of Formula (II) is hydrogen. The degree of permanent quaternization of Formula (II) is 0% of the polyethyleneimine backbone nitrogen atoms. The molecular weight of this polyethyleneimine preferably is about from about 25,000 to about 30,000, most preferably about 28,000.

These polyethyleneimines can be prepared, for example, by polymerizing ethyleneimine in the presence of a catalyst such as carbon dioxide, sodium bisulfite, sulfuric acid, hydrogen peroxide, hydrochloric acid, acetic acid, and the like, as described in more detail in PCT Publication No. WO 2007/135645.

### EO-PO-EO Tri-Block Co-Polymer

The composition of the present invention preferably comprises an EO-PO-EO tri-block co-polymer defined according to Formula (I): (EO)x(PO)y(EO)x, wherein EO represents ethylene oxide, and each x represents the number of EO units within the EO block. Each x is independently on average between 1 and 80, preferably between 3 and 60, more preferably between 5 and 50, most preferably between 5 and 30. Preferably x is the same for both EO blocks, wherein the “same” means that the x between the two EO blocks varies within a maximum 2 units, preferably within a maximum of 1 unit, more preferably both x's are the same number of units. PO represents propylene oxide, and y represents the number of PO units in the PO block. Each y is on average between 1 and 60, preferably between 10 and 55, more preferably between 10 and 50, more preferably between 15 and 48. The tri-block co-polymers according to the invention are preferably present in the composition at a level of from about 0.1 wt % to about 10 wt %, preferably from about 0.5 wt % to about 7.5 wt %, more preferably from about 1 wt % to about 5 wt %, by weight of the total composition.

### Chelant

The detergent composition herein can comprise a chelant at a level of from about 0.1% to about 20%, preferably from about 0.2% to about 5%, more preferably from about 0.2% to about 3% by weight of total composition.

As commonly understood in the detergent field, chelation herein means the binding or complexation of a bi- or multidentate ligand. These ligands, which are often organic compounds, are called chelants, chelators, chelating agents, and/or sequestering agent. Chelating agents form multiple bonds with a single metal ion. Chelants, are chemicals that form soluble, complex molecules with certain metal ions, inactivating the ions so that they cannot normally react with other elements or ions to produce precipitates or scale, or forming encrustations on soils turning them harder to be removed. The ligand forms a chelate complex with the substrate. The term is reserved for complexes in which the metal ion is bound to two or more atoms of the chelant.

Preferably, the composition of the present invention comprises one or more chelant, preferably selected from the group comprising carboxylate chelants, amino carboxylate chelants, amino phosphonate chelants such as MGDA (methylglycine-N,N-diacetic acid), GLDA (glutamic-N,N-diacetic acid), and mixtures thereof.

Suitable chelating agents can be selected from the group consisting of amino carboxylates, amino phosphonates, polycarboxylate chelating agents and mixtures thereof.

Other chelants include homopolymers and copolymers of polycarboxylic acids and their partially or completely neutralized salts, monomeric polycarboxylic acids and hydroxycarboxylic acids and their salts. Suitable polycarboxylic acids are acyclic, alicyclic, heterocyclic and aromatic carboxylic acids, in which case they contain at least two carboxyl groups which are in each case separated from one another by, preferably, no more than two carbon atoms. A suitable hydroxycarboxylic acid is, for example, citric acid. Another suitable polycarboxylic acid is the homopolymer of acrylic acid. Preferred are the polycarboxylates end capped with sulfonates.

### Adjunct Ingredients

The cleaning composition herein may optionally comprise a number of other adjunct ingredients such as builders (e.g., preferably citrate), cleaning solvents, cleaning amines, conditioning polymers, cleaning polymers, surface modifying polymers, soil flocculating polymers, structurants, emollients, humectants, skin rejuvenating actives, enzymes, carboxylic acids, scrubbing particles, bleach and bleach activators, perfumes, malodor control agents, pigments, dyes, opacifiers, beads, pearlescent particles, microcapsules, inorganic cations such as alkaline earth metals such as Ca/Mg-ions, antibacterial agents, preservatives, viscosity adjusters (e.g., salt such as NaCl, and other mono-, di- and trivalent salts) and pH adjusters and buffering means (e.g., carboxylic acids such as citric acid, HCl, NaOH, KOH, alkanolamines, phosphoric and sulfonic acids, carbonates such as sodium carbonates, bicarbonates, sesquicarbonates, borates, silicates, phosphates, imidazole and alike).

### Method of Washing

In another aspect, the invention is directed to a method of manually washing dishware comprising the steps of delivering a detergent composition of the invention into a volume of water to form a wash solution and immersing the dishware in the solution. As such, the composition herein will be applied in its diluted form to the dishware. Soiled surfaces e.g. dishes are contacted with an effective amount, typically from about 0.5 mL to about 20 mL (per 25 dishes being treated), preferably from about 3 mL to about 10 mL, of the detergent composition of the present invention, preferably in liquid form, diluted in water. The actual amount of detergent composition used will be based on the judgment of user, and will typically depend upon factors such as the particular product formulation of the composition, including the concentration of active ingredients in the composition, the number of soiled dishes to be cleaned, the degree of soiling on the dishes, and the like. Generally, from about 0.01 mL to about 150 mL, preferably from about 3 mL to about 40 mL of a liquid detergent composition of the invention is combined with from about 2,000 mL to about 20,000 mL, more typically from about 5,000 mL to about 15,000 mL of water in a sink having a volumetric capacity in the range of from about 1,000 mL to about 20,000 mL, more typically from about 5,000 mL to about 15,000 mL. The soiled dishes are immersed in the sink containing the diluted compositions then obtained, where contacting the soiled surface of the dish with a cloth, sponge, or similar article cleans them. The cloth, sponge, or similar article may be immersed in the detergent composition and water mixture prior to being contacted with the dish surface, and is typically contacted with the dish surface for a period of time ranged from about 1 to about 10 seconds, although the actual time will vary with each application and user. The contacting of cloth, sponge, or similar article to the surface is preferably accompanied by a concurrent scrubbing of the surface.

In another aspect, the invention is directed to a method of manually washing dishware with the composition of the present invention. The method comprises the steps of: i) delivering a composition of the present invention onto the dishware or a cleaning implement; ii) cleaning the dishware with the composition in the presence of water; and iii) optionally, rinsing the dishware. The delivering step is preferably either directly onto the dishware surface or onto a cleaning implement, i.e., in a neat form. The cleaning device or implement is preferably wet before or after the composition is delivered to it. Especially good grease removal has been found when the composition is used in neat form.

In another aspect, the invention is directed to a method of manually washing soiled articles comprising contacting a detergent composition of the invention with a surface, and wherein the composition modifies the hydrophobicity of the surface as a result of the contacting step.

Another aspect of the present invention is directed to a method of promoting suds longevity or grease emulsification in a washing process for washing soiled articles, preferably dishware. The method comprises the steps of: a) delivering a detergent composition of the invention to a volume of water to form a wash liquor; and b) immersing the soiled articles into said wash liquor. Preferably, the plant derived protein or blend of plant derived proteins according to the invention is present at a concentration of about 0.005 ppm to about 60 ppm, preferably at a concentration of about 0.02 ppm to about 12 ppm, in an aqueous wash liquor during the washing process.

Another aspect of the present invention is use, in a hand dishwashing detergent composition, of a combination of: i) a plant derived protein or blend of plant derived proteins selected from the group consisting of a Pea protein, a Chickpea protein, a Lentil protein, a Bean protein, and mixtures thereof, most preferably a Pea protein; and ii) a surfactant system comprising an anionic surfactant and a primary co-surfactant selected from the group consisting of amphoteric surfactant preferably an amine oxide surfactant, a zwitterionic surfactant preferably a betaine surfactant, and mixtures thereof, preferably the primary co-surfactant is amine oxide, wherein the weight ratio of anionic surfactant to the primary co-surfactant is less than about 9:1, more preferably from about 5:1 to about 1:1, more preferably from about 4:1 to about 2:1; to provide enhanced suds boosting and/or increased suds longevity in an aqueous wash liquor during a hand dish washing process, especially when in the presence of greasy soils.

### Test Methods

The following assay set forth must be used in order that the invention described and claimed herein may be more fully understood.

### Test Method 1: Glass Vial Suds Mileage

The method measures the evolution of suds volume over time generated by a certain solution of test detergent composition in the presence of a greasy soil, e.g., olive oil. The following factors may affect the measurement results and therefore should be controlled carefully: (a) concentration of the test detergent composition; (b) hardness of the water; (c) water temperature; (d) speed of stirring; and (e) speed and number of the shaking. Following steps are followed to obtain the suds measurements for each test detergent composition:
1. Test solutions are prepared by subsequently adding aliquots into 40 mL glass vials (dimensions: 95 mm Height×27.5 mm Diameter), preferably graduated vials at room temperature, of: a) 10 g of an aqueous detergent solution at 0.11% detergent concentration and water hardness (15° dh), and b) 0.11 g of olive oil (Bertolli®, Extra Virgin Olive Oil). The test detergent contains 2% of the plant derived protein and is compared with a nil-plant derived protein detergent.
2. The test solutions are mixed in the closed test vials by stirring at room temperature for 2 minutes at 500 RPM on a magnetic stirring plate (IKA, model # RTC B S001; VWR magnetic stirrer, catalog #58949-012), followed by manually shaking for 20 seconds with an upwards downwards movement (about 2 up and down cycles per second, +/−30 cm up and 30 cm down) and the initial suds heights (H1) are recorded with a ruler. H1 is a measurement of the suds height.
3. Following the shaking, the test solutions in the closed vials are further stirred at 500 RPM on the magnetic stirring plate for 60 minutes inside a water bath at 35° C. to maintain a constant temperature. The samples are then shaken manually for another 20 seconds as described above. The final suds heights (H2) are recorded.
4. The Suds Stability Index (SSI) of an individual sample is expressed as (H2/H1)*100. Protein solutions that produce larger suds heights (H1 and H2), preferably combined with lower drops in suds height between H1 and H2, are more desirable, i.e., high H1 and high suds stability index. A Protein Impact Index (PII) can be further calculated by cross-comparing the Suds Stability Index of the protein comprising sample versus a reference sample single variably lacking the protein, i.e. (SSI (protein sample)/SSI (nil protein reference))*100.

### EXAMPLES

The following examples are provided to further illustrate the present invention and are not to be construed as limitations of the present invention, as many variations of the present invention are possible without departing from its spirit or scope.

### Example 1: Plant Derived Protein Detergent Compositions Impact on Suds Mileage

The ability to maintain suds mileage in the presence of greasy soil, i.e. olive oil, is assessed for test detergent compositions with or without the plant derived protein. The compositions are summarized in Table 1. Composition Ex. 4 is a plant derived protein containing test detergent compositions according to the present invention, made with surfactant system comprising Alkyl(C12/C13)-0.6 ethoxylated sulfate and Alkyl(C12/C14)-dimethyl amine oxide in 4:1 weight ratio, in the presence of 2% Pea protein. Composition Ex. 3 is a reference composition containing the same surfactant system as in Test Composition Ex. 4 in the absence of the pea protein. Composition Ex. 2 is a test composition containing the Alkyl(C12/C13)-0.6 ethoxylated sulfate minus the amine oxide in the presence of the Pea protein. Composition Ex. 1 is a reference composition to Test Composition Ex. 2. Reference Composition Ex. 1 contains Alkyl(C12/C13)-0.6 ethoxylated sulfate minus the amine oxide in the absence of the Pea protein. The compositions are produced through standard mixing of the components described in Table 1.

TABLE 1
Detergent Compositions

| | Reference | Test | Reference | Test |
|---|---|---|---|---|
| | Comp. | Comp. | Comp. | Comp. |
| Ingredients | Ex. 1 | Ex. 2 | Ex. 3 | Ex. 4 |
| Sodium alkyl ethoxy sulfate | 26.25% | 26.25% | 21% | 21% |
| (C1213EO0.6S) | | | | |
| n-C12-14 Di Methyl Amine | — | — | 5.25% | 5.25% |
| Oxide | | | | |
| Lutensol ® XP80 (non- | 1% | 1% | 1% | 1% |
| ionic surfactant supplied | | | | |
| by BASF) | | | | |
| Sodium Chloride | 0.7% | 0.7% | 0.7% | 0.7% |
| Poly Propylene Glycol | 0.7% | 0.7% | 0.7% | 0.7% |
| (MW 2000) | | | | |
| Ethanol | 2% | 2% | 2% | 2% |
| Sodium Hydroxide | 0.2% | 0.2% | 0.2% | 0.2% |
| Pea protein* | — | 2% | — | 2% |
| Minors (perfume, | To | To | To | To |
| preservative, | 100% | 100% | 100% | 100% |
| dye) + water | | | | |
| pH (@ 0.12% solution) | 8.35 | 8.35 | 8.35 | 8.35 |

*Pea protein from Myprotein (UK).

The Compositions Ex. 1-4 are tested for the suds volume (i.e., suds height) and suds stability and the data (not shown) are recorded. The Suds Stability Index (“SSI”) for each of the compositions is calculated (not shown) according to Test Method 1. A Protein Impact Index (“PII”), which is a unitless number that indicates the relative impact of the plant derived protein on the suds mileage of a test composition as compared to a reference composition which is missing the protein, is calculated. The PII is calculated by dividing the SSI for the test composition containing the plant derived protein by the SSI for the reference composition minus the plant derived protein, followed by multiplying the quotient by 100. The higher the PII, the better the suds mileage performance of the test composition.

The PPI results for Test Composition Ex. 4 vs. Reference Composition Ex. 3 are summarized in Table 2, and the PPI results for Test Composition Ex. 2 vs. Reference Composition Ex. 1 are summarized in Table 3.

TABLE 2
Performance on Suds Stability of Composition containing
Pea Protein with AES/AQ Surfactant System

| Composition | Protein Impact Index (PII) |
|---|---|
| Reference Comp. Ex. 3 | 100 |
| Test Comp. Ex. 4 | 127* |

*vs. Reference Comp. Ex. 3.

It is clear from the results in Table 2 that the addition of the Pea protein to a surfactant system (AES/AO) within the scope of the present invention leads to an enhanced increase of suds duration, particularly in the presence of greasy soil, as evidenced by a PII of 127.

TABLE 3
Performance on Suds Stability of Composition containing
Pea Protein with AES Surfactant System

| Composition | Protein Impact Index |
|---|---|
| Reference Comp. Ex. 1 | 100 |
| Test Comp. Ex. 2 | 68* |

*vs. Reference Comp. Ex. 1.

The data in Table 3 shows that the addition of the Pea protein according to the invention to a surfactant system (AES and no primary co-surfactant) outside the scope of the invention results in a suds mileage represented by PII of 68. This suds mileage is a noticeable drop when compared to the Test Comp. Ex. 4 with PII of 127. Therefore, the enhanced increased suds mileage performance of the composition comprising the plant derived protein with the specific surfactant system according to the present invention is unexpected and a synergy between the specific surfactant system and the protein of the invention is observed.

All percentages and ratios herein are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition comprising:
a) from about 5 wt % to about 50 wt % by weight of the composition of a surfactant system, wherein the surfactant system comprises:
i) an anionic surfactant; and
ii) a primary co-surfactant selected from the group consisting of an amphoteric surfactant, a zwitterionic surfactant preferably a betaine surfactant, and mixtures thereof;
wherein the weight ratio of the anionic surfactant to the primary co-surfactant is less than about 9:1; and
b) from about 0.1 wt % to about 10 wt %, by weight of the composition of a vegetable protein or blend of vegetable proteins derived from a Leguminous plant family selected from the group consisting of Fabaceae (or Leguminosae), preferably Vicia faba, Vigna aconitifolia, Vigna angularis, Vigna mungo, Vigna radiata, Vigna subterranea, Vigna umbellata, Vigna unguiculata, Psophocarpus tetragonolobus, Phaseolus acutifolius, Phaseolus coccineus, Phaseolus lunatus, Phaseolus polyanthus, Phaseolus vulgaris Canavalia gladiata, Canavalia ensiformis, Lupinus mutabilis, Lupinus albus, Cicer arietinum, Lens culinaris and Pisum savitum, preferably Vicia faba, Cicer arietinum, Lens culinaris, and Pisum savitum;
wherein the detergent composition is a hand dishwashing detergent composition.

2. The composition according to claim 1, wherein the composition comprises from 15 wt % to 40 wt % by weight of the composition of the surfactant system

3. The composition according to claim 1, wherein the anionic surfactant is selected from the group consisting of alkyl sulfate, alkyl alkoxy sulfate, and mixtures thereof.

4. The composition according to claim 1, wherein the primary co-surfactant is an amphoteric surfactant which is an amine oxide surfactant.

5. The composition according to claim 1, wherein the vegetable protein or blend of vegetable proteins is selected from the group consisting of Pea protein, Chickpea protein, Lentil Protein, Bean Protein, and mixtures thereof.

6. The composition according to claim 5, wherein the vegetable protein or blend of vegetable proteins is selected from the group consisting of Pea protein, wherein the Pea protein is a Pea protein isolate comprising:
i) a first Pea protein isolate component comprising a Pea Albumin protein, from about 20 wt % to about 95 wt %, by weight of the total Pea protein level in the composition;
ii) a second Pea protein isolate component comprising a Pea Vicilin protein and/or a Pea Convicilin protein, from about 5 wt % to about 80 wt %, by weight of the total Pea protein level in the composition; and
iii) a third Pea protein isolate component comprising a Pea Legumin protein, from about 0 wt % to about 30 wt %, by weight of the total Pea protein level in the composition.

7. The composition according to claim 5, wherein the vegetable protein or blend of vegetable proteins is selected from the group consisting of Chickpea protein, wherein the Chickpea protein is a Chickpea protein isolate comprising:
i) a first Chickpea protein isolate component comprising a Chickpea Albumin protein, from about 20 wt % to about 95 wt %, by weight of the total Chickpea protein level in the composition; and
ii) a second Chickpea protein isolate component comprising a Chickpea Globulin protein, from about 5 wt % to about 80 wt %, by weight of the total Chickpea protein level in the composition.

8. The composition according to claim 5, wherein the vegetable protein or blend of vegetable proteins is selected from the group consisting of Lentil protein, wherein the Lentil protein is a Lentil protein isolate comprising:
i) a first Lentil protein isolate component comprising a Lentil Albumin protein, from about 20 wt % to about 95 wt %, by weight of the total Lentil protein level in the composition; and
ii) a second Lentil protein isolate component comprising a Lentil Globulin protein, from about 5 wt % to about 80 wt %, by weight of the total Lentil protein level in the composition.

9. The composition according to claim 5, wherein the vegetable protein or blend of vegetable proteins is selected from the group consisting of Bean protein, wherein the Bean protein is a Bean protein isolate comprising:
i) a first Bean protein isolate component comprising a Bean Albumin protein, from about 10 wt % to about 90 wt %, by weight of the total Bean protein level in the composition;
ii) a second Bean protein isolate component comprising a Bean Vicilin protein and/or a Bean Convicilin protein, from about 5 wt % to about 85 wt %, more preferably from 5 wt % to 50 wt %, by weight of the total Bean protein level in the composition; and
iii) a third Bean protein isolate component comprising a Bean Legumin protein, from about 5 wt % to about 95 wt %, by weight of the total Bean protein level in the composition.

10. The composition according to claim 5, wherein the vegetable protein or blend of vegetable proteins is selected from the group consisting of Pea protein, wherein the Pea protein has at least about 50% amino acid identity to a Pea Legumin protein (SEQ ID NOs: 1-8), a Pea Vicilin protein or a Pea Convicilin protein (SEQ ID NOs: 9-24), or a Pea Albumin protein (SEQ ID NOs: 25-31).

11. The composition according to claim 5, wherein the vegetable protein or blend of vegetable proteins is selected from the group consisting of Bean protein, wherein the Bean protein has at least about 80% amino acid identity to a Bean Legumin protein (SEQ ID NOs: 32-36), a Bean Vicilin protein or a Bean Convicilin protein (SEQ ID NOs: 37-39), or a Bean Albumin protein (SEQ ID NOs: 40-49).

12. The composition according to claim 5, wherein the vegetable protein or blend of vegetable proteins is selected from the group consisting of Chickpea protein, wherein the Chickpea protein has at least about 80% amino acid identity to a Chickpea Legumin protein (SEQ ID NOs: 50-56), a Chickpea Vicilin protein or a Chickpea Convicilin protein (SEQ ID NOs: 57-70), or a Chickpea Albumin protein (SEQ ID NOs: 71-76).

13. The composition according to claim 5, wherein the vegetable protein or blend of vegetable proteins is selected from the group consisting of Lentil protein, the Lentil protein has at about least 80% amino acid identity to a Lentil Vicilin protein or a Lentil Convicilin protein (SEQ ID NOs: 77-80).

14. The composition according to claim 1, wherein the Pulse protein comprises a subunit or a protomer of a Globulin.

15. The composition according to claim 1, wherein the composition comprises a protein-bound carbohydrate content of 0.5% or less by weight of the composition.

16. The composition according to claim 1, wherein:
i) the anionic surfactant is an alkyl ethoxy sulfate with an average degree of ethoxylation of less than about 5, wherein the alkyl ethoxy sulfate has an average alkyl carbon chain length of from 8 to 16; and
ii) the primary co-surfactant is an amine oxide selected from the group consisting of linear or branched alkyl amine oxide, linear or branched alkyl amidopropyl amine oxide, and mixtures thereof.

17. The composition according to claim 18, wherein the anionic sulfate has a weight average level of branching of from about 20% to about 45%.

18. The composition according to claim 1, further comprising from 1.5% to 5%, by weight of the surfactant system of a non-ionic surfactant, comprising on average from 9 to 15 carbon atoms in its alkyl chain and on average from about 5 to about 12 units of ethylene oxide per mole of alcohol.

19. A method of manually washing dishware comprising the steps of delivering a composition according to claim 1 to a volume of water to form a wash liquor and immersing the dishware in the wash liquor, or delivering a composition according to claim 1 directly onto the dishware or cleaning implement and using the cleaning implement to clean the dishware.


SEQUENCE LISTING (80 sequences)

SEQ ID NO: 1 - protein, 517 aa, Pisum sativum
MAKLLALSLSFCFLLLGGCFALREQPQQNECQLERLDALEPDNRIESEGGLIETWNPNNKQFRCAGVALSRATLQRNALRRPYYSNAPQEIFIQQGNGYFGMVFPGCPETFEEPQESEQGEGRRYRDRHQKVNRFREGDIIAVPTGIVFWMYNDQDTPVIAVSLTDIRSSNNQLDQMPRRFYLAGNHEQEFLQYQHQQGGKQEQENEGNNIFSGFKRDYLEDAFNVNRHIVDRLQGRNEDEEKGAIVKVKGGLSIISPPEKQARHQRGSRQEEDEDEEKQPRHQRGSRQEEEEDEDEERQPRHQRRRGEEEEEDKKERGGSQKGKSRRQGDNGLEETVCTAKLRLNIGPSSSPDIYNPEAGRIKTVTSLDLPVLRWLKLSAEHGSLHKNAMFVPHYNLNANSIIYALKGRARLQVVNCNGNTVFDGELEAGRALTVPQNYAVAAKSLSDRFSYVAFKTNDRAGIARLAGTSSVINNLPLDVVAATFNLQRNEARQLKSNNPFKFLVPARESENRASA

SEQ ID NO: 2 - protein, 503 aa, Pisum sativum
MSKPFLSLLSLSLLLFASACLATSSEFDRLNQCQLDSINALEPDHRVESEAGLTETWNPNHPELKCAGVSLIRRTIDPNGLHLPSFSPSPQLIFIIQGKGVLGLSFPGCPETYEEPRSSQSRQESRQQQGDSHQKVRRFRKGDIIAIPSGIPYWTYNHGDEPLVAISLLDTSNIANQLDSTPRVFYLGGNPETEFPETQEEQQGRHRQKHSYPVGRRSGHHQQEEESEEQNEGNSVLSGFSSEFLAQTFNTEEDTAKRLRSPRDERSQIVRVEGGLRIIKPKGKEEEEKEQSHSHSHREEKEEEEEEEEDEEEKQRSEERKNGLEETICSAKIRENIADAARADLYNPRAGRISTANSLTLPVLRYLRLSAEYVRLYRNGIYAPHWNINANSLLYVIRGEGRVRIVNCQGNTVFDNKVRKGQLVVVPQNFVVAEQAGEEEGLEYVVFKTNDRAAVSHVQQVFRATPSEVLANAFGLRQRQVTELKLSGNRGPLVHPRSQSQSH

SEQ ID NO: 3 - protein, 520 aa, Pisum sativum
MATKLLALSLSFCFLLLGGCFALREQPEQNECQLERLNALEPDNRIESEGGLIETWNPNNKQFRCAGVALSRATLQHNALRRPYYSNAPQEIFIQQGNGYFGMVFPGCPETFEEPQESEQGEGRRYRDRHQKVNRFREGDIIAVPTGIVFWMYNDQDTPVIAVSLTDIRSSNNQLDQMPRRFYLAGNHEQEFLRYQHQQGGKQEQENEGNNIFSGFKRDFLEDAFNVNRHIVDRLQGRNEDEEKGAIVKVKGGLSIISPPEKQARHQRGSRQEEDEDEDEERQPRHQRGSRQEEEEDEDEERQPRHQRRRGEEEEEDKKERRGSQKGKSRRQGDNGLEETVCTAKLRLNIGPSSSPDIYNPEAGRIKTVTSLDLPVLRWLKLSAEHGSLHKNAMFVPHYNLNANSIIYALKGRARLQVVNCNGNTVFDGELEAGRALTVPQNYAVAAKSLSDRFSYVAFKTNDRAGIARLAGTSSVINNLPLDVVAATFNLQRNEARQLKSNNPFKFLVPARQSENRASA

SEQ ID NO: 4 - protein, 566 aa, Pisum sativum
MARHFLSSFSLCFLLFTTACLAHHSESDRFNQCQLDTINALEPDHRVESEAGLTETWNPNHPELKCAGVSLIRRTIDPNGLHLPSYSPSPQLIFIIQGKGVLGLAVPGCPETYEEPRSQSRRQQQQRDSHQKIRRFSKGDVIAIPPGIPYWTYNHGHEPLVAITLLDTSNTLNQLDSTPRVFYLGGNPEIEFPETQQKQHEPRQQRYSFLVGRRGGQQQEEESEEQNEGNSVLSGFNVEFLAHSLNTKEDTAKRLRSPQDERGQIVKVEDGLHIISPELQEEEEQSHSQRKEEEEEEQEQRHRKHSKKEDEDEDEEEEEEREQRHRKHSEKEEEDEDEPRSYETRRKWKKHTAEKERESHGQGEEEEELEKEEEEEEGIQRQHSKGRKNGLEETICSAKIRENIARPSRGDLYNSGAGRISTVNSLTLPILRNLRLSAEYVLLYRNGIYAPHWNINANSLLYVIRGEGRVRIVNSEGNKVFDDKVSLGQLVVVPQNFVVAQQAGNEEGFEYVVFKTNDRAAVSHVNQVFRATPGEVLANAFGLRHSQVAQIKSNGNRGPLVQPQSQ

SEQ ID NO: 5 - protein, 517 aa, Pisum sativum
MAKLLALSLSFCFLLLGGCFALREQPQQNECQLERLDALEPDNRIESEGGLIETWNPNNKQFRCAGVALSRATLQRNALRRPYYSNAPQEIFIQQGNGYFGMVFPGCPETFEEPQESEQGEGRRYRDRHQKVNRFREGDIIAVPTGIVFWMYNDQDTPVIAVSLTDIRSSNNQLDQMPRRFYLAGNHEQEFLQYQHQQGGKQEQENEGNNIFSGFKRDFLEDAFNVNRHIVDRLQGRNEDEEKGAIVKVKGGLSIISPPEKQARHQRGSRQEEDEDEEKQPRHQRGSRQEEEEDEDEERQPRHQRRRGEEEEEDKKERGGSQKGKSRRQGDNGLEETVCTAKLRLNIGPSSSPDIYNPEAGRIKTVTSLDLPVLRWLKLSAEHGSLHKNAMFVPHYNLNANSIIYALKGRARLQVVNCNGNTVFDGELEAGRALTVPQNYAVAAKSLSDRFSYVAFKTNDRAGIARLAGTSSVINNLPLDVVAATFNLQRNEARQLKSNNPFKFLVPARESENRASA

SEQ ID NO: 6 - protein, 216 aa, Pisum sativum
KGGLRIISPPEKQARHQRGSQKGKSRRQGDNGLEETVCTAKLRLNIGPSSSPDIYNPEAGRIKTVTSLDLPVLRWLKLSAEHGSLHKNTMFVPHYNLNANSIIYALKGRARLQVVNCNGNTVFDGKLEAGRALTVPQNYAVAAKSLNDRFSYVAFKTNDRAGIARLAGTSSVINDLPLDVVAATFKLQRDEARQLKSNNPFKFLVPARQSENRASA

SEQ ID NO: 7 - protein, 338 aa, Pisum sativum
GNSVLSGFNVEFLAHSLNTKEDTAKRLRSPQDERGQIVKVEDGLHIISPELQEEEEQSHSQRKEEEEEEQEQRHRKHSKKEDEDEDEEEEEEREQRHRKHSEKEEEDEDEPRSYETRRKWKKHTAEKKRESHGQGEEEEELEKEEEEEEEIQRQHSKGRKNGLEETICSAKIRENIARPSRGDLYNSGAGRISTVNSLTLPILRNLRLSAEYVLLYRNGIYAPHWNINANSLLYVIRGEGRVRIVNSEGNKVFDDKVSLGQLVVVPQNFVVAQQAGNEEGFEYVVFKTNDRAAVSHVNQVFRATPGEVLANAFGLRHSQVAQIKSNGNRGPLVQPQSQ

SEQ ID NO: 8 - protein, 350 aa, Pisum sativum
IPYWTYNHGDEPLVAISLLDTSNIANQLDSTPRVFYLGGNPETEFPETQEEQQGRHRQKHSYPVGRRSGHHQQEEESEEQNEGNSVLSGVSSEFLAQTFNTEEDTAKRLRSPRDERSQIVRVEGGLRIINPKGKEEEEEKEQSHSHSHREEEEEEEEDEEKQRSEERKNGLEETICSAKIRENIADAAGADLYNPRAGRIRTANSLTLPVLRYLRLSAEYVRLYRNGIYAPHWNINANSLLYVIRGEGRVRIVNFQGDAVFDNKVRKGQLVVVPQNFVVAEQAGEEEGLEYVVFKTNDRAAVSHVQQVLRATPAEVLANAFGLRQRQVTELKLSGNRGPLVHPQSQSQSH

SEQ ID NO: 9 - protein, 459 aa, Pisum sativum
MAATTMKASFPLLMLMGISFLASVCVSSRSDPQNPFIFKSNKFQTLFENENGHIRLLQKFDQRSKIFENLQNYRLLEYKSKPHTIFLPQHTDADYILVVLSGKAILTVLKPDDRNSFNLERGDTIKLPAGTIAYLVNRDDNEELRVLDLAIPVNRPGQLQSFLLSGNQNQQNYLSGFSKNILEASFNTDYEEIEKVLLEEHEKETQHRRSLKDKRQQSQEENVIVKLSRGQIEELSKNAKSTSKKSVSSESEPFNLRSRGPIYSNEFGKFFEITPEKNPQLQDLDIFVNSVEIKEGSLLLPHYNSRAIVIVTVNEGKGDFELVGQRNENQQEQRKEDDEEEEQGEEEINKQVQNYKAKLSSGDVFVIPAGHPVAVKASSNLDLLGFGINAENNQRNFLAGDEDNVISQIQRPVKELAFPGSAQEVDRILENQKQSHFADAQPQQRERGSRETRDRLSSV

SEQ ID NO: 10 - protein, 438 aa, Pisum sativum
MAATPIKPLMLLAIAFLASVCVSSRSDQENPFIFKSNRFQTLYENENGHIRLLQKFDKRSKIFENLQNYRLLEYKSKPHTLFLPQYTDADFILVVLSGKATLTVLKSNDRNSFNLERGDAIKLPAGTIAYLANRDDNEDLRVLDLAIPVNKPGQLQSFLLSGTQNQPSLLSGFSKNILEAAFNTNYEEIEKVLLEQQEQEPQHRRSLKDRRQEINEENVIVKVSREQIEELSKNAKSSSKKSVSSESGPFNLRSRNPIYSNKFGKFFEITPEKNQQLQDLDIFVNSVDIKEGSLLLPNYNSRAIVIVTVTEGKGDFELVGQRNENQGKENDKEEEQEEETSKQVQLYRAKLSPGDVFVIPAGHPVAINASSDLNLIGFGINAENNERNFLAGEEDNVISQVERPVKELAFPGSSHEVDRLLKNQKQSYFANAQPLQRE

SEQ ID NO: 11 - protein, 437 aa, Pisum sativum
MAATPIKPLMLLAIAFLASVCVSSRSDQENPFIFKSNRFQTLYENENGHIRLLQKFDKRSKIFENLQNYRLLEYKSKPRTLFLPQYTDADFILVVLSGKATLTVLKSNDRNSFNLERGDTIKLPAGTIAYLANRDDNEDLRVLDLAIPVNKPGQLQSFLLSGTQNQPSLLSGFSKNILEAAFNTNYEEIEKVLLEQQEQEPQHRSLKDRRQEINEENVIVKVSREQIEELSKNAKSSSKKSVSSESGPFNLRSRNPIYSNKFGKFFEITPEKNQQLQDLDIFVNSVDIKEGSLLLPNYNSRAIVIVTVTEGKGDFELVGQRNENQGKENDKEEEQEEETSKQVQLYRAKLSPGDVFVIPAGHPVAINASSDLNLIGFGINAENNERNFLAGEEDNVISQVERPVKELAFPGSSHEVDRLLKNQKQSYFANAQPLQRE

SEQ ID NO: 12 - protein, 441 aa, Pisum sativum
MAATPMKASFPLLMLMGISFLASVCVSSRSDPQNPFIFKSNKFQTLFENENGHIRLLQKFDQRSKIFENLQNYRLLEYKSKPRTLFLPQYTDADFILVVLSGKATLTVLKSNDRNSFNLERGDTIKLPAGTIAYLANRDDNEDLRVLDLAIPVNKPGQLQSFLLSGTQNQPSLLSGFSKNILEAAFNTNYEEIEKVLLEQQEQEPQHRSLKDRRQEINEENVIVKVSREQIEELSKNAKSSSKKSVSSESGPFNLRSRNPIYSNKFGKFFEITPEKNQQLQDLDIFVNSVDIKEGSLLLPNYNSRAIVIVTVTEGKGDFELVGQRNENQGKENDKEEEQEEETSKQVQLYRAKLSPGDVFVIPAGHPVAINASSDLNLIGFGINAENNERNFLAGEEDNVISQVERPVKELAFPGSSHEVDRLLKNQKQSYFANAQPLQRE

SEQ ID NO: 13 - protein, 438 aa, Pisum sativum
MAATPIKPLMLLAIAFLASVCVSSRSDQENPFIFKSNRFQTLYENENGHIRLLQKFDKRSKIFENLQNYRLLEYKSKPHTLFLPQYTDADFILVVLSGKATLTVLKSNDRNSFNLERGDAIKLPAGTIAYLANRDDNEDLRVLDLAIPVNKPGQLQSFLLSGTQNQPSLLSGFSKNILEAAFNTDYEEIEKVLLEEHEKETQHRRSLKDKRQQSQEENVIVKLSRGQIEELSKNAKSTSKKGVSSESEPFNLRSRGPIYSNEFGKFFEITPGKNQQLQDLDIFVNSVDIKEGSLLLPNYNSRAIVIVTVTEGKGDFELVGQRNENQGKENDKEEEQEEETSKQVQLYRAKLSPGDVFVIPAGHPVAINASSDLNLIGFGINAENNERNFLAGEEDNVISQVERPVKELAFPGSSHEVDRLLKNQKQSYFANAQPLQRE

SEQ ID NO: 14 - protein, 438 aa, Pisum sativum
MAATPIKPLMLLAIAFLASVCVSSRSDQENPFIFKSNRFQTLYENENGHIRLLQKFDKRSKIFENLQNYRLLEYKSKPRTLFLPQYTDADFILVVLSGKATLTVLKSNDRNSFNLERGDTIKLPAGTIAYLANRDDNEDLRVLDLTIPVNKPGQLQSFLLSGTQNQPSLLSGFSKNILEAAFNTNYEEIEKVLLEQQEQEPQHRRSLKDRRQEINEENVIVKVSREQIEELSKNAKSSSKKSVSSESGPFNLRSRNPIYSNKFGKFFEITPEKNQQLQDLDIFVNSVDIKEGSLLLPNYNSRAIVIVTVTEGKGDFELVGQRNENQGKENDKEEEQEEETSKQVQLYRAKLSPGDVFVIPAGHPVAINASSDLNLIGFGINAENNERNFLAGEEDNVISQVERPVKELAFPGSSHEVDRLLKNQKQSYFANAQPLQRE

SEQ ID NO: 15 - protein, 438 aa, Pisum sativum
MAATPIKPLMLLAIAFLASVCVSSRSDQENPFIFKSNRFQTLYENENGHIRLLQKFDKRSKIFENLQNYRLLEYKSKPHTLFLPQYTDADFILVVLNGKATLTVLKSNDRNSFNLERGDTIKLPAGTIAYLANRDDNEDLRVLDLAIPVNKPGQLQSFLLSGTQNQPSLLSGFSKNILEAAFNTNYEEIEKVLLEQQEQEPQHRRSLKDRRQEINEENVIVKVSREQIEELSKNAKSSSKKSVSSESGPFNLRSRNPIYSNKFGKFFEITPEKNQQLQDLDIFVNSVDIKEGSLLLPNYNSRAIVIVTVTEGKGDFELVGQRNENQGKENDKEEEQEEETSKQVQLYKAKLSPGDVFVIPAGHPVAINASSDLNLIGFGINAENNERNFLAGEEDNVISQVQRPVKELAFPGSSHEIDRLLKNQKQSYFANAQPLQRE

SEQ ID NO: 16 - protein, 415 aa, Pisum sativum
SRSDQENPFIFKSNRFQTLYENENGHIRLLQKFDKRSKIFENLQNYRLLEYKSKPHTLFLPQYTDADFILVVLSGKATLTVLKSNDRNSFNLERGDAIKLPAGTIAYLANRDDNEDLRVLDLAIPVNKPGQLQSFLLSGTQNQPSLLSGFSKNILEAAFNTNYEEIEKVLLEQQEQEPQHRRSLKDRRQEINEENVIVKVSREQIEELSKNAKSSSKKSVSSESGPFNLRSRNPIYSNKFGKFFEITPEKNQQLQDLDIFVNSVDIKEGSLLLPNYNSRAIVIVTVTEGKGDFELVGQRNENQGKENDKEEEQEEETSKQVQLYRAKLSPGDVFVIPAGHPVAINASSDLNLIGFGINAENNERNFLAGEEDNVISQVERPVKELAFPGSSHEVDRLLKNQKQSYFANAQPLQRE

SEQ ID NO: 17 - protein, 415 aa, Pisum sativum
SRSDQENPFIFKSNRFQTLYENENGHIRLLQKFDKRSKIFENLQNYRLLEYKSKPRTLFLPQCTDADFILVVLSGKATLTVLKSNDRNSFNLERGDTIKLPAGTIAYLANRDDNEDLRVLDLTIPVNKPGQLQSFLLSGTQNQPSLLSGFSKNILEAAFNTNYEEIEKVLLEQQEQEPQHRRSLKDRRQEINEENVIVKVSREQIEELSKNAKSSSKKSVSSESGPFNLRSRNPIYSNKFGKFFEITPEKNQQLQDLDIFVNSVDIKEGSLLLPNYNSRAIVIVTVTEGKGDFELVGQRNENQGKENDKEEEQEEETSKQVQLYRAKLSPGDVFVIPAGHPVAINASSDLNLIGFGINAENNERNFLAGEEDNVISQVERPVKELAFPGSSHEVDRLLKNQKQSYFANAQPLQRE

SEQ ID NO: 18 - protein, 451 aa, Pisum sativum
MATTIKSRFPLLLLLGIMFLASVVCVTYANYDEGSEPRVPAQRERGRQEGEKEEKRHGEWRPSYEKEEDEEEGQRERGRQEGEKEEKRHGEWRPSYEKQEDEEEKQKYRYQREKEDGEEKQKYQYQREKKEEKEVQPGRERWEREEDEEQVEEEWRGSQRREDPEERARLRHREERTKRDRRHQSEGEEEERSSESLERRNPFLFKSNKFLTLFENENGHIRLLQRFDKRSDLFENLQNYRLVEYRAKPHTIFLPQHIDADLILVVLNGKAILTVLSPNDRNSYNLERGDTIKLPAGTTSYLVNQDDEEDLRLVDLVIPVNGPGKFEAFDLAKNKNQYLRGFSKNILEASYNGALMLPHYNSRAIVVLLVNEGKGNLELLGLKNEQQEREDRKERNNEVQRYEARLSPGDVVIIPAGHPVAITASSNLNLLGFGINAENNERNFLSGSDDN

SEQ ID NO: 19 - protein, 571 aa, Pisum sativum
MATTVKSRFPLLLFLGIIFLASVCVTYANYDEGSETRVPGQRERGRQEGEKEEKRHGEWRPSYEKEEHEEEKQKYRYQREKKEQKEVQPGRERWEREEDEEQVEEEWRGSQRREDPEERARLRHREERTKRDRRHQREGEEEERSSESQEHRNPFLFKSNKFLTLFENENGHIRRLQRFDKRSDLFENLQNYRLVEYRAKPHTIFLPQHIDADLILVVLNGKAILTVLSPNDRNSYNLERGDTIKIPAGTTSYLVNQDDEEDLRVVDFVIPVNRPGKFEAFGLSENKNQYLRGFSKNILEASLNTKYETIEKVLLEEQEKKPQQLRDRKRTQQGEERDAIIKVSREQIEELRKLAKSSSKKSLPSEFEPFNLRSHKPEYSNKFGKLFEITPEKKYPQLQDLDILVSCVEINKGALMLPHYNSRAIVVLLVNEGKGNLELLGLKNEQQEREDRKERNNEVQRYEARLSPGDVVIIPAGHPVAISASSNLNLLGFGINAKNNQRNFLSGSDDNVISQIENPVKELTFPGSSQEVNRLIKNQKQSHFASAEPEQKEEESQRKRSPLSSVLDSFY

SEQ ID NO: 20 - protein, 511 aa, Pisum sativum
MATTVKSRFPLLLFLGIIFLASVCVTYANYDEGSETRVPGQRERGRQEGEKEEKRHGEWRPSYEKEEHEEEKQKYRYQREKKEQKEVQPGRERWEREEDEEQVEEEWRGSQRREDPEERARLRHREERTKRDRRHQREGEEEERSSESQEHRNPFLFKSNKFLTLFENENGHTRRLQRFDKRSDLFENLQNYRLVEYRAKPHTIFLPQHIDADLILVVLNGKAILTVLSPNDRNSYNLERGDTIKVPAGTTSYLVNQDDEEALRVVDFVIPVNRPGKFEAFGLSENKNQYLRGFSKNILEASLNTKYETIEKVLLEEQEKKPQQLRDRKRTQQGEERDAIIKVSREQIEELRKLAKSSSKKSLPSEFEPFNLRSHKPEYSNKFGKLFEITPEKKYPQLQDLDILVSCVEINKGALMLPHYNSRAIVVLLVNEGKGNLELLGLKNEQQEREDRKERNNEVQRYEARLSPGDVVIIPAGHPVAISASSNLNLLGFGINAKNNQRNFLSGSDDN

SEQ ID NO: 21 - protein, 511 aa, Pisum sativum
MATTVKSRFPLLLFLGIIFLASVCVTYANYDEGSETRVPGQRERGRQEGEKEEKRHGEWRPSYEKEEDEEEKQKYRYQREKKEQKEVQPGCERWEREEDEEQVDEEWRGSQRREDPEERARLRHREERTKRDRRHQREGEEEERSSQSQEHRNPFLFKSNKFLTLFENENGHIRRLQRFDKRSDLFENLQNYRLVEYRAKPHTIFLPQHIDADLILVVLNGKAILTVLSPNDRNSYNLERGDTIKIPAGTTSYLVNQDDEEDLRVVDFVIPVNRPGKFEAFGLSENKNQYLRGFSKNILEASLNTKYETIEKVLLEEQEKKPQQLRDRKRRQQGEERDAIIKVSREQIEELRKLAKSSSKKSLPSEFEPFNLRSHKPEYSNKFGKLFEITPEKKYPQLQDLDILVSCVEINKGALMLPHYNSRAIVVLLVNEGKGNLELLGLKNEQQEREDRKERNNEVQRYEARLSPGDVVIIPAGHPVAITASSNLNLLAFGINAENNQRNFLSGSDDN

SEQ ID NO: 22 - protein, 613 aa, Pisum sativum
MATTIKSRFPLLLLLGIIFLASVVCVTYANYDEGSEPRVPAQRERGRQEGEKEEKRHGEWRPSYEKEEDEEEGQRERGRQEGEKEEKRHGEWRPSYEKQEDEEEKQKYRYQREKEDEEEKQKYQYQREKKEQKEVQPGRERWEREEDEEQVDEEWRGSQRREDPEERARLRHREERTKRDRRHQREGEEEERSSESQERRNPFLFKSNKFLTLFENENGHIRLLQRFDKRSDLFENLQNYRLVEYRAKPHTIFLPQHIDADLILVVLSGKAILTVLSPNDRNSYNLERGDTIKLPAGTTSYLVNQDDEEDLRLVDLVIPVNGPGKFEAFDLAKNKNQYLRGFSKNILEASYNTRYETIEKVLLEEQEKDRKRRQQGEETDAIVKVSREQIEELKKLAKSSSKKSLPSEFEPINLRSHKPEYSNKFGKLFEITPEKKYPQLQDLDLFVSCVEINEGALMLPHYNSRAIVVLLVNEGKGNLELLGLKNEQQEREDRKERNNEVQRYEARLSPGDVVIIPAGHPVAITASSNLNLLGFGINAENNERNFLSGSDDNVISQIENPVKELTFPGSVQEINRLIKNQKQSHFANAEPEQKEQGSQGKRSPLSSILGTFY

SEQ ID NO: 23 - protein, 572 aa, Pisum sativum
MATTIKSRFPLLLLLGIIFLASVVSVTYANYDEGSEPRVPAQRERGRQEGEKEEKRHGEWRPSYEKEEDEEEGQRERGRQEGEKEEKRHGEWGPSYEKQEDEEEKQKYRYQREKEDEEEKQKYQYQREKKEQKEVQPGRERWEREEDEEQVDEEWRGSQRREDPEERARLRHREERTKRDRRHQREGEEEERSSESQERRNPFLFKSNKFLTLFENENGHIRLLQRFDKRSDLFENLQNYRLVEYRAKPHTIFLPQHIDADLILVVLNGKAILTVLSPNDRNSYNLERGDTIKLPAGTTSYLVNQDDEEDLRLVDLVIPVNGPGKFEAFDLAKNKNQYLRGFSKNILEASYNAFDLAKNKNQYLRGFSKNILEASYNTKYETIEKVLLEEQEKEPQQRRAIVKVSRGQIEELRKLAKSSSKKSLPSEFEPINLRSHKPEYSNKFGKLFEITPEKKYPQLQDLDLFVSCVEINEGALMLPHYNSRAIVVLLVNEGKGNLELLGLKNEQQEREDRKERNNEVQRYEARLSPGDVVIIPAGHPVAITASSNLNLLAFGINAENNERNFLSGSDDN

SEQ ID NO: 24 - protein, 527 aa, Pisum sativum
MATTIKSRFPLLLLLGIIFLASVVCVTYANYDEGSEPRVPAQRERGRQEGEKEEKRHGEWRPSYEKQEDEEEKQKYRYQREKEDEEEKQKYRYQREKKEEKEVRPGRERWEREEDEEQVEEEWRGSQRREDPEERARLRHREERTKRDRRHQREGEEEERSSESQERGNPFLLKSNKFLTLFENENGHIRLLQRFDKRSDLFENLQNYRLVEYRAKPHTIFLPQHIDADLILVVLSGKAILTVLSPNDRNSYNLERGDTIKLPAGTTSYLVNQDDEEDLRLVDLVIPVNGPGKFEAFDLAKNKNQYLRGFSKNILEASYNTKYETIEKVLLEEQEKEPQQRRDRKRRQQGQETDAIVKVSREQIEELRKLAKSSSKKSLPSEFEPINLRSHKPEYSNKFGKLFEITPEKKYPQLQDLDLFVSCVEINEGALMLPHYNSRAIVVLLVNEGKGNVELLGLKNEQQEREDRKERNNEVQRYEARLSPGDVVIIPAGHPVAITASSNLNLLGFGINAENNERNFLSGSDDN

SEQ ID NO: 25 - protein, 130 aa, Pisum sativum
MASVKLASLIVLFATLGMFLTKNVGAASCNGVCSPFEMPPCGTSACRCIPVGLVIGYCRNPSGVFLRTNDEHPNLCESDADCRKKGSGKFCGHYPNPGIEYGWCFASKSEAEDFFSKITQKDLLKSVSTA

SEQ ID NO: 26 - protein, 130 aa, Pisum sativum
MASVKLASLIVLFATLGMFLTKNVGAISCNGVCSPFDIPPCGSPLCRCIPAGLVIGNCRNPYGVFLRTNDEHPNLCESDADCRKKGSGTFCGHYPNPDIEYGWCFASKSEAEDVFSKITPKDLLKSVSTA

SEQ ID NO: 27 - protein, 130 aa, Pisum sativum
MASVKLASLIVLFATLGMFLTKNVGAASCNGVCSPFEMPPCGTSACRCIPVGLFIGYCRNPSGVFLKANDEHPNLCESDADCRKKGSGNFCGHYPNPDIEYGWCFASKSEAEDFFSKITPKDLLKSVSTA

SEQ ID NO: 28 - protein, 130 aa, Pisum sativum
MASVKLASLMVLFATLGMFLTKNVGAASCNGVCSPFEMPPCGSSACRCIPVGLVVGYCRHPSGVFLRTNDEHPNLCESDADCRKKGSGNFCGHYPNPDIEYGWCFASKSEAEDFFSKITQKDLLKSVSTA

SEQ ID NO: 29 - protein, 130 aa, Pisum sativum
MASVKLASLIVLFATLGMFLTKNVGAASCNGVCSPFEMPPCGTSACRCIPVGLVVGYCRNPSGVFLRTNDEHPNLCESDADCRKKGSGNFCGHYPNPDIEYGWCFASKSEAEDFFSKITPKDLLKSVSTA

SEQ ID NO: 30 - protein, 130 aa, Pisum sativum
MASVKLASLIVLFATLGMFLTKNVGAASCNGVCSPFEMPPCGSSACRCIPVGLLIGYCRNPSGVFLKGNDEHPNLCESDADCKKKGSGNFCGHYPNPDIEYGWCFASKSEAEDVFSKITPKDLLKSVSTA

SEQ ID NO: 31 - protein, 231 aa, Pisum sativum
MTKTGYINAAFRSSQNNEAYLFINDKYVLLDYAPGTSNDKVLYGPTPVRDGFKSLNQTVFGSYGVDCSFDTDNDEAFIFYEKFCALIDYAPHSNKDKIILGPKKIADMFPFFEGTVFENGIDAAYRSTRGKEVYLFKGDQYARIDYETNSMVNKEIKSIRNGFPCFRNTIFESGTDAAFASHKTNEVYFFKGDYYARVTVTPGATDDQIMDGVRKTLDYWPSLRGIIPLEN

SEQ ID NO: 32 - protein, 484 aa, Vicia faba
MSKPFLSLLSLSLLLFTSTCLATSSEFDRLNQCRLDNINALEPDHRVESEAGLTETWNPNHPELRCAGVSLIRRTIDPNGLHLPSYSPSPQLIYIIQGKGVIGLTLPGCPQTYQEPRSSQSRQGSRQQQPDSHQKIRRFRKGDIIAIPSGIPYWTYNNGDEPLVAISLLDTSNIANQLDSTPRVFYLVGNPEVEFPETQEEQQERHQQKHSLPVGRRGGQHQQEEESEEQKDGNSVLSGFSSEFLAHTFNTEEDTAKRLRSPRDKRNQIVRVEGGLRIINPEGQQEEEEEEEEEKQRSEQGRNGLEETICSLKIRENIAQPARADLYNPRAGSISTANSLTLPILRYLRLSAEYVRLYRNGIYAPHWNINANSLLYVIRGEGRVRIVNSQGNAVFDNKVTKGQLVVVPQNFVVAEQAGEEEGLEYLVFKTNDRAAVSHVQQVFRATPADVLANAFGLRQRQVTELKLSGNRGPLVHPQSQSQSN

SEQ ID NO: 33 - protein, 335 aa, Vicia faba
GIPYWTYNNGDEPLVAISLLDTSNIANQLDSTPRVFYLGGNPEVEFPETQEEQQERHQQKHSLPVGRRGGQHQQEEESEEQKDGNSVLSGFSSEFLAQTFNTEEDTAKRLRSPRDKRNQIVRVEGGLRIINPEGQQEEEEEEEEEKQRSEQGRNGLEETICSLKIRENIAQPARADLYNPRAGSISTANSLTLPILRYLRLSAEYVRLYRNGIYAPHWNINANSLLYVIRGEGRVRIVNSQGNAVFDNKVRKGQLVVVPQNFVVAEQAGEEEGLEYLVFKTNDRAAVSHVQQVFRATPADVLANAFGLRQRQVTELKLSGNRGPLVHPQSQSQSN

SEQ ID NO: 34 - protein, 329 aa, Vicia faba
GIPYWTYNNGDEPLVAISLLDTSNIANQLDSTPRVFYLGGNPEVEFPETQEEQQERHQQKHSLPVGRRGGQHQQEEDGNSVLSGFSSEFLAQTFNTEEDTAKRLRSPRDKRNQIVRVEGGLRIINPEGQQEEEEEEEEEKQRSEQGRNGLEETICSLKIRENIAQPARADLYNPRAGSISTANSLTLPILRYLRLSAEYVRLYRNGIYAPHWNINANSLLYVIRGEGRVRIVNSQGNAVFDNKVRKGQLVVVPQNFVVAEQAGEEEGLEYLVFKTNDRAAVSHVQQVFRATPADVLANAFGLRQRQVTELKLSGNRGPLVHPQSQSQSN

SEQ ID NO: 35 - protein, 335 aa, Vicia faba
GIPYWTYNNGDEPLVAISLLDTSNIANQLDSTPRVFYLGGNPEVEFPETQEEQQERHQQKHSLPVGRRGGQHQQEEESEEQKDGNSVLSGFSSEFLAQTFNTEEDTAKRLRSPRDKRNQIVRVEGGLRIINPEGQQEEEEQEEEEKQRSEQGRNGLEETICSLKIRENIAQPARADLYNPRAGSISTANSLTLPILRYLRLSAEYVRLYRNGIYAPHWNINANSLLYVIRGEGRVRIVNSQGNAVFDNKVRKGQLVVVPQNFVVAEQAGEEEGLEYLVFKTNDRAAVSHVQQVFRATPADVLANAFGLRQRQVTELKLSGNRGPLVHPHSQSQSN

SEQ ID NO: 36 - protein, 606 aa, Vicia faba
MSRPFTLSLLSLCLLLFAPACLGTTNLFNRCRINSLNALKPDHRVESNGGLIETWSSTHRELECAGVTFSRRTIYRNGLHMPSYSPYPQMIIAVQGKGALGLAIPGCPQTYEEAVDESTSSQKPSDCHQKILQFSEGHVLLIPPGVPYWTYNTGHESLIIVSLLYTSNDYNQLDQSPREFYLAGNPDIEHPEAIKEQKQVEEEGSNVLGGFGKRFLARSLDIDEDIAKKLVSPEDEMKQIVKLKDGLSVISPKWQGLQDEDEDDKEEDEDESQGKRVHKKEEKEVEPLPHGKRVHKKEEKEVEPLPPHGKRVHKEEEKEVEPLPPRKHVHKEEEKEVEPLPHRKHLRKEEEEEKPRARRTRGPTPSPGGEGHRVVEEEEEYDEPVRHKTRHEKSWKEDQPAEEVVEKGEAHEEWETKQSKDKNRGSNGIEETLCTLKLQHNIARASSADFFNPKAGRISNLNSLTLPVLQQLGLSAQYVVLYKNGIYSPHWNLNANSVIYVIRGQGQVRVVNSEGIAVFDDELKKGQLLVVPQNFMVAEEAGEQGFEYVVFKTNPNAVTSYLKDTFRSFPAEVIAKIYKLSHSEVSELKFEGNWGPLINPVKSQSS

SEQ ID NO: 37 - protein, 463 aa, Vicia faba
MAATTLKDSFPLLTLLGIAFLASVCLSSRSDQDNPFVFESNRFQTLFENENGHIRLLQKFDQHSKLLENLQNYRLLEYKSKPHTIFLPQQTDADFILVVLSGKAILTVLLPNDRNSFSLERGDTIKLPAGTIGYLVNRDDEEDLRVLDLVIPVNRPGEPQSFLLSGNQNQPSILSGFSKNILEASFNTDYKEIEKVLLEEHGKEKYHRRGLKDRRQRGQEENVIVKISRKQIEELNKNAKSSSKKSTSSESEPFNLRSREPIYSNKFGKFFEITPKRNPQLQDLNIFVNYVEINEGSLLLPHYNSRAIVIVTVNEGKGDFELVGQRNENQQGLREEYDEEKEQGEEEIRKQVQNYKAKLSPGDVLVIPAGYPVAIKASSNLNLVGFGINAENNQRYFLAGEEDNVISQIHKPVKELAFPGSAQEVDTLLENQKQSHFANAQPRERERGSQEIKDHLYSILGSF

SEQ ID NO: 38 - protein, 477 aa, Vicia faba
MATTNKSRFALVLLPGIIFLASVCVTCANYDEGSEPRVPGKRERGRQEGEKEEKRHGEWSPSHEKEAQPGRERWERKEDEEQVEEEWRGSQRHEDPDERERERNREERTKRKEEEKRGERDTRHQHEGEEEESSSKSQERRNPFLFKSNKFLTLFQNKNGYIRRLQRFDTRSDLFENLQNYRLVEYRAKPHTIFLPQHIDADLILVVFSGKAILTVLSPNDRNSYNLERGDTIKIPAGTTSYLVNQDDEQDLEAFDLSRNKNQYLRAFSKNILEASLNTKYETIEKVLLEERRQQGKETNAIVKLSREQIAELRKLAKSSSKRSLPSKFEPINLRSQNPKYSNKFGRLFEITPEKKYPQLQDLDIFVSFSEISEGALLLPHYNSRAIVVLVVNEGQGNLELVGFKNEQQEQSLKEDEQQERNKQVQRYEARLSPGDVVVIPSGHPFSVSALSNLTLFGFGINAENNERNFLTGSDDN

SEQ ID NO: 39 - protein, 497 aa, Vicia faba
MATTNKSRFPLVLLLGIIFLASVCVTCANYDEGSEPRVPGQRERGRQEGEKEEKRHGEWSPSREKEAQPGRERWERKEDEEQVEEEWRGSQRHEDPDERARERYRAETTKKRVEEEREERYTPYQPEGEEEKGSSKSQERRNPFLFKSNKFLTLFENENGHIRLLQRFDKRSDLFENLQNYRLVEYRAKPHTIFLPQHIEADLILTVLSGKAILTVLSPNDRNSYNLERGDTIKVPAGTTSYLVNQDDEQDLRVVDLAISVNRPGKVESFNLYGNKNQYLRGFSKNILEASFNTKYETIEKVLLEEQDKESQQSIGQRRRSQRQETNALVRVSRQQIEELKRLAKSSSKKGVSSELEPFNLRSQNPKYSNKFGKLFEITPEKKYPQLQDLDIFISSVEIKEGALILPHYNSRAIVVLLVNEGKGNLELVGIQNEQQEQQERNKQVQRYEARLSPGDVVIIPAGHPVAVSASSNLNLFAFGINAENNQRNFLTGSDDN

SEQ ID NO: 40 - protein, 127 aa, Vicia faba
MGYVRVAPLALFLLATSMMFSMKKIEAVVCSGVCSPFEMPPCGSSDCRCVPYGLFIGSCIHPTGLSAAAKMIDEHPNLCQSHEECMKKGSGNFCARYPNHYMDYGWCFNSDSDALKGFLAMPRAISK

SEQ ID NO: 41 - protein, 127 aa, Vicia faba
MGYVRVAPLALFLLATSMMFSMKKIEAVVCSGFCSPFEMPPCGSSDCRCVPYGLFVGSCIHPTGLSAAAKMIDEHPNLCQFHEECMKKGSGNFCARYPNHYMDYGWCFNSDFDALKGFLAMPRAISK

SEQ ID NO: 42 - protein, 126 aa, Vicia faba
MAYVRVAPLALFLLATSIMFPMKIEAVDCSGACSPFEVPPCGSRDCRCIPIALFVGFCIYPTGLSSVSKMIDEHPNLCQSHGECMKKGSGNFCARYPNHYVDYGWCFNSGSEELKGFLAMPRAISK

SEQ ID NO: 43 - protein, 128 aa, Vicia faba
MGYVRVAPLALFLLATSIMFPMKKTEAVVCSGLCSPFEVPPCGSARDCRCIPVGLVVCFCTNPSGLSSVAKTIDEHPNICQTHEECTKKGSGNFCARYPNHYMDYGWCFNSGSEELKGFLAMPRAISK

SEQ ID NO: 44 - protein, 128 aa, Vicia faba
MGYVRVAPLALFLLATSIMFPMKKTEAVVCSGVCSPFERPPCGSTRDCRCIPYGLFIGACTNPSGLSSVAKTIDEHPNICQTHEECTKKGSGNFCARYPNDYMDYGWCFNSDSEELKGFLAMPRAISK

SEQ ID NO: 45 - protein, 127 aa, Vicia faba
MGYVRVAPLTLFLLATSIMFWMKKTEAVVCSGVCSPFEMPPCGSSDCRCIPYGLFIGACTYPRGLSSVAKTIDEHPNLCQSHGECMKKGSGNFCARYPNDYVDYGWCFNSDSDELKGFLAMPREISK

SEQ ID NO: 46 - protein, 127 aa, Vicia faba
MGYVRVAPLALFLLATSMMFSMKKIEAVVCSGFCSPFEMPPCGSSDCRCVPYGLFVGSCIHPTGLSAAAKMIDEHPNLCQFHEECMKKGSGNFCARYPNHYMDYGWCFNSDSDALKGFLAMPRAISK

SEQ ID NO: 47 - protein, 127 aa, Vicia faba
MGYVRVAPSALFLLATSIMFSMKKTEAVVCSGVCSPFEMPPCGSSDCRCIPYGLFIGACTYPRGLSSVAKTIGEHPNLCQSHGECIKKGSGNFCARYPNDYVDYGWCSNSDSEELKGFLAMPREISK

SEQ ID NO: 48 - protein, 132 aa, Vicia faba
MGFVRVAPLALFFLVTSILVMFSMKNIEAVDCSGACSPASHEPPCGSSDCRCLPVIAPFVGTCYHPTALSSSVAKMIDEHPNLCESDEECIKKGTGNFCARYPNHYVDYGWCFNSGSDELKGFLAMPTAISK

SEQ ID NO: 49 - protein, 227 aa, Vicia faba
MAYINAAFRSSREYEVYFFLKKNHYVRVHYTPGKTDDKILTNLRLISSGFPSLAGTPFAEQGIDSAFDTEGKEAYVFSTKHCAYIDYAPGTTNDKILKGPTTIAEMFPVLKNTVFENGIDSAFRSIKGKEVYLFKGNKYTRIDYDSKQLIGNIRNITDGFTVLKGTVFESGIDACFASHEESEAYLFKGNQYVRIKYTPGSSNDTLLGDVRPILDGWPCLKDILSGN

SEQ ID NO: 50 - protein, 358 aa, Cicer arietinum
MELDLTPKVAETLLEGDGGGYYIWLSSQVPVLAKTNVGAGQLVLRPRGFALPHYADSNKIGYVIQGTNGVAGLVLPNSGKEVVVKLKKGDVIPVPIGGVSWWFNDGDSDLNIIFLGETSKAHVPGEFTYFFLNGIQGLLASFSSDLISKVYNFNQDEVNKLTQSQSGVVIISVEKGQPMPKPQLELTKELVYDIDAAGPNIEAQNGGLVTILTDKELPFIKEVGLSVIRVKLEPNAIKAPSNLITPGIQLIYIARGGGKIEIVGLNGKRVLDAQVKVGHLIVVPRFFVVAKIAGEEGMETYSIVTTTKPLFEELAGKKSVWGVLSPTVQEVSFNVNSEFQKLFISKATLDTNLIPPTI

SEQ ID NO: 51 - protein, 496 aa, Cicer arietinum
MAKLLALSLSFCFLLFGTCFALRDQPQQNECQLEHLNALKPDNRIKSEGGLIETWNPSNKQFACAGVALSRATLQPNSLLQTFLHQRSPEIFIQQGNGYFGMVFPGCVETFEEPRESEQGEGSKFSDSHQKVNRFREGDIIAVPTGVVFWMFNDQDTPVIAVSLIDTSSFQNQLDQMPRRFYLAGNHEQEFLRYQQEGSEEEENEGGNIFSGFKRDFLEDALNVNRRIVNKLQGRNEDEEKGAIVKVKGGLSITTPPEKEPRQKRGSRQEEDEDEDEKRQPHRHSRQDEDEDEKRQPHHHSRGGSKSQRDNGFEETICTARLHQNIGSSSSPDIYNPQAGRIKTVTSFDLQALRFLKLSAEFGSLHKNAMFVPHYNLNANSILYALKGRARLLYALNCKGNSVFDGELEAGRALIVPQNFAIAAKSLSDRFSYVAFKTNDRALINVCQKKLLQLLSIWKEMRPGSSSSTAPFHFLFHPAVTQTTKQQLDLVPNQYE

SEQ ID NO: 52 - protein, 499 aa, Cicer arietinum
  misc_feature (189)..(196): Xaa can be any naturally occurring amino acid
MAKLLALSLSFCFLLFGSCFALRDQPEQNECQLEHLNALEPDNRIKSEGGLIETWNPSNKQFRCAGVALSRATLQPNSLRRPFYTNAPQEIFIQQGNGYFGMVFPGCVETFEEPRESEQGEGSKFRDSHQKVNRFREGDIIAVPTGVVFWMFNDQDTPVIAVSLIDTSSFQNQLDQMPRRFYLAGNHEXXXXXXXXQQEGSEEEENEGGNIFSGFKRDFLEDALNVNRRIVNKLQGRNEDEEKGAIVKVKGGLSIITPPEKEPRQKRGSRQEEDEDEDEKRQPHRHSRQDEDEDEKRQPRRHSRGGSKSQRDNGFEETICTARLHQNIGSSSSPDIYNPQAGRIKTVTSFDLPALRFLKLSAEFGSLHKNAMFVPHYNLNANSILYALKGRARLQIVNCKGNSVFDGELEAGRALIVPQNFAIAAKSLSDRFSYVAFKTNDRAAIGRLLGASSLINGMPEEVVAAAFNMERNEARQLKFNSPFSFLVPPRSDSDNKAAA

SEQ ID NO: 53 - protein, 532 aa, Cicer arietinum
MRRSNSYLSSLSLCFLLFTSACLATRSEEFDRFNQCQLDSINALEPDHRVESEAGLTETWNPNHPELQCAGVSLIRRTIDPNGLHIPSFSPSPQLIFIVQGKGVLGLSIPGCPTTFEEQRQHFDNHQKIRRFSKGDIIAIPPGIPYWSYNNGDEPVVAITLLDTSNFANQLDSTPRVFYLGGNPEVEFPETQQQQQQQKRHSLPFPGGRKGGKNQQEEQNEGNSVLSGFSSEFLAQALNTDEDTAKKLQSPRDQRAQIVRVEGGLRIISPDLQDEEDEDEDEDEQEQGHSQREEEEDDDEDESHSHESRQKWRKYREEEKQGSHRREHKEEEEEEEEKICKKRSCRGKGRKNGLEETICSARIRENIIRPARADLYNPRAGRISTVNSLTLPILSYLRLSAEYVLLYRNGINAPHWNMNANSLMYVVRGEGKVRIVNCEGKAVFDDNVRKGQMLVVPQNFVVAEQAGNEEGFEYVVFKTNDRAAVSNVKQVFRATPAQVLANAFGLRQNEVTKIKFSGNRGPLVQPRSHAHA

SEQ ID NO: 54 - protein, 518 aa, Cicer arietinum
MAKLLALSLSLCFLLFGGCFAFREQPQQNECQLEHLNALEPDNRIESEGGLIETWNPNNRQFRCAGVALSRATLQRNALRRPFYTNAPQEIFIQQGNGYFGMVFPGCPETFMEPRESEQREGRRFRDSHQKVNRFREGDIIAVPTGVVFWMYNDQDTPVIAVSLIDTSSFQNQLDQMPRRFYLAGNQEQEFLQYQQQEGRKEEQENEGNNIFSGFRRDFLEDALNVNRHIVDKLQGRDEDEEKGAIVKVKGGLSFISPSEKQPRHQRGSRQEEDEDEDEDEKRQPHRHSRQDEDEDEKRRPRRHSRQDEDEDEEEKRQPRRHSRGGSRSQRDNGFEETICTARLHQNIDSSSSPDIYIPQAGRIKTVTSFDLPALRWLKLSAEHGSLHKNAMFVPHYNLNANSILYALKGRARLQVVNCNGNNVFDGELEAGRALIVPQNFAVAAKSMSDRFSYVAFKTNDRAAIGKLVGATSSLSSIPEDVIAATFNMERNEARKLKSSNPFTFLVPPRESENKAAA

SEQ ID NO: 55 - protein, 455 aa, Cicer arietinum
MCWCCPLSCYPSTQCPSQTFLHQRSPGNFHPTGNGYFGMVFPGCPETFMEPRESEQREGRRFRDSHQKVNRFREGDIIAVPTGVVFWMYNDQDTPVIAVSLIDTSSFQNQLDQMPRRFYLAGNQEQEFLQYQQQEGRKEEQENEGNNIFSGFRRDFLEDALNVNRHIVDKLQGRDEDEEKGAIVKVKGGLSFISPSEKQPRHQRGSRQEEDEDEDEDEKRQPHRHSRQDEDEDEKRRPRRHSRQDEDEDEEEKRQPRRHSRGGSRSQRDNGFEETICTARLHQNIDSSSSPDIYIPQAGRIKTVTSFDLPALRWLKLSAEHGSLHKNAMFVPHYNLNANSILYALKGRARLQVVNCNGNNVFDGELEAGRALIVPQNFAVAAKSMSDRFSYVAFKTNDRAAIGKLVGATSSLSSIPEDVIAATFNMERNEARKLKSSNPFTFLVPPRESENKAAA

SEQ ID NO: 56 - protein, 551 aa, Cicer arietinum
MAKPNPHILHYFFSLFCLLLFTCGCSSRQLPRQQSEFNECQLDSIDALEPDNRIESEAGLTEIWDANHPELRCAGVSVLKRTINANGLHLPSYVTYPELHFVEQGTGVLGMAIPGCAETYEEPQWERRGRPQLQQDRHQKVRYVKQGDLIAIPPGVPYWTYNYGNTPLIIITLLDTSNPLNQLDRTPTRFYLAGNPETEKQSGRKRGQEEEEEESNNMFSGFDSRFLGQVLKVKESIIRKLQSPDKHRKHQIIEVKGGLSIIRPPLEPEIRSEEEETHRRHTEKRVEEREEEVEDEPCKREHREWRRERRTHGEGEGEGGCEGEEEEVVEEKETKTKERRRHGEREEKQTRTTTREREGQKDNSLEETVCTLKLHENIADPSRADVFNPRAGRITTANSLTLPVLKSLHLSAQWVNLYKDGIFVPHWNMNSNGVMYVTRGKGRVQVVNNEGKSVFNGEVGRGQLLVVPQNFAVAKQAGNEGMEYVAFKTNDRAEISTMIGRNSAISATPGEVLANAFGLSPEEVIALKNNRNEGVLATPDSRIQDGYIAML

SEQ ID NO: 57 - protein, 440 aa, Cicer arietinum
MSNSIFQYLLLLFFIAPTFSQQSFRPKALVLPVTKDTLTTNQYIAQINQRTPLVPLNLVVDLGGQFLWLDCEQHYTSSTYRPARCRSAQCSLAKSTACGDCFSSPKPGCNNNTCGLFPDNTVTHTATSGELAEDVLSVQSTNGFNPTQNVAVSRFLFSCAPTSLLQGLASGASGMAGLGRTKIAFPSQLASAFSFDRKFAICFSSSDGVVLFGDGPYGFLANNRSLPNVVYDSESLTYTPLLINPVSTASAFTQGEPSAEYFIGVKKIKIDKKVVALNTSLLTINSNGFGGTKLSTVNPYTVLESSIYKAVTDAFVKASVARNITRTDSFEPFEFCYSFDNLSGTRLGAAVPTIELVLQNENVVWSIFGANSMVNINDDVLCLGFMNGGENVRTSIVIGGYQLDNNLLQFDLAASRLGFSGSVFARQTDCFRFNSTTSIA

SEQ ID NO: 58 - protein, 440 aa, Cicer arietinum
MASISILHFLFCFFLLVLSSESTTQTQSHSQSQQNSNSKPNLLVLPVQQDANTGLHWAYIHKRTPLMQLPVLIDLNGKHLWVNCEQHYSSSTYQAPFCHSTQCARANTHTCHTCVSSFRPGCHNNTCGLMSANPVTQQTALGELAQDVFAIYTTRGPKLGPMVTVPQFLFSCAPSFLAQKGLPNNVQGVAGLAHSPISLPNQLSSHFGLKHQFTTCLSRYPKSNGAIIFGDAANNMRFGNNRNYKNNPNILNNLIYTPLTITPEGEYRMHVTSIQINEHTVVPVSGSMLSSYPEGVIGGTLISTSIPYTTLQDSLFETFVQVFAKQFPKEAQVNAVGPFGLCFDSKRINKAVNVEFVLDRSDVVWRISGENLMVEAKSGISCLGIVNGGLKPKATISIGSRQLEENLLLFDLVESKLGFSNSLSSRGIKCSDLFDFNNNA

SEQ ID NO: 59 - protein, 436 aa, Cicer arietinum
MSSSNFQLQHLITLLLFFFISSTFSQQSFRPKALVLPVTKDTSTTNQYIAQINQRTPLVPLNLVVDLGGQFLWLDCEQHYTSSTYRPARCRSAQCSLAKSTACGDCFSSPKPGCNNNTCSIFPDNTVTHTATSGELAEDVLSIQSTNGFNPTQNVAVSRFLFSCAPTSLLEGLASGASGMAGLGRTKIAFPSQLASAFSFDRKFAICFSSSDGVVLFGDGPYGFLPNVVYDSESLTYTPLLINPVSTASAFTQGEPSAEYFIGVKKIKIDDKVVSLNTSLLSINSNGIGGTKISTVDPYTVLEASIYKAVTDGFVKASVARNLTRVDSFHPFEFCYTNLGGTRLGAAVPTIELVLQNENVVWSIFGANSMVNINDEVSCLGFVNGGENVRTSIVIGGYQLDNNLLQFDLAASRLGFSSTLFGRQTGCYNFNFTSAT

SEQ ID NO: 60 - protein, 431 aa, Cicer arietinum
MKIVPSFLFFYTLIITLISPSIASTLIQPKALVLPVTKDSATSQYVTLIHQRTPLLPIKLTLDLSGQFLWINCEKGYVSSTYHPAHCTTKQCSITKSKFCRNCFLSKPGCNNNTCNLFPNNIFTHINEIGEVALDVVAIHSTNGLSLGKIVTVKNFLFTCGRTNLLKGLASGVKGMAGFGRSEISVPSLFASAFSLNKKFSICLSSSSGVLFFGDGPFVFLPRIDVSKFLIFTPLIKNPDNSAGPIFHGRLGAEYFIGVKAIRINEKLISLNTSLLSIGDEGEGGTKISTLNPYTIMETSIYNSFVDAFAKELEDVPKAKAIKPFKLCFKLKDLGVTRVGLAVPTIDFMLQNKDVFWRMFGANSMVQVNNKVSCLAFLDGGVEVTTSIVIGGYQLEDNFLQFDLVNSRLGFSSSLLFLQTTCANFNFTSSI

SEQ ID NO: 61 - protein, 448 aa, Cicer arietinum
MTTSYLFLFSLSLISLISSSVALTKPHTPKPNNAFILPIAKDPITLQYSTTINMGTPAVTLDLVVDIRERFLWFECDESYNSSTYHPIQCGTKKCKQSKGAECIDCINHPLKTGCTNHTCGVQPFNPFGEFYVSGDIGEDIISSLRGTLSNVNVPRVISSCIYPNKFGVQGFLQGLAKGKKGILGLARTFISLPTQLATRYKLDRKFTLCLPSTSNSDGLGLGSLFIGGGPYHLPSQKIDASKFLEYTPLITNRHSTGPIFDNLPSTEYFIKVKSIKVDNNIINFNNSLLSIRKKLGIGGTKLSTVIPHTKLHTLIYKSLLNAFVKKAEIRKIKRVKEVAPFGACFDSRTIGKSVTGPNVPTIDFVLKGGVEWRFYGANSMVKVGRNVLCLGFVDGGNEEVGPWDTSIVIGGHQLEDNLLEFDLVSSKLGFSSSLLLNKASCSHFKGF

SEQ ID NO: 62 - protein, 429 aa, Cicer arietinum
MSSFSSIIHFFLLSLPLLSISCLSLSQPPNTKPNPFILPIKKDPSTNLFYTSVGIGTPRKDFNLAIDLAGENLWYDCDTHYNSSSYIPIECGSKKCPDVACIGCNGPFKPGCTNNTCAANTINTLANFIFGGGLGQDFIFISQQKVSGLLSSCIDTDGFPSFTGNDSPLNGLPKITKGIIGLARSNLSLPTQLALKNELPPKFSLCLPSSNKQGFTNLLVGSIGKDPFQELYKFVQTTPLIVNPVSTGAVSVQGVPSIEYFIDVKAIKIDGKVVNLKPSLLSIDNKGNGGTKISTMSPFTELQRSVYKPFIRDFLKKASDRKLKKVESVAPFEACFESTNIENSLPRIDLVLQGGVQWSIYGNNLMVNVKKNVACLGFVDGGTEPRMSFAKASIVIGGHQLEDNLLVFDLNSSKLSFSSSLLVHNASCS

SEQ ID NO: 63 - protein, 443 aa, Cicer arietinum
MLVEMVVSTKLLTLLSIISLIISTSTAQTSLRPKALVLPITKDISSTTPQYVTQIKQRTPLVPIKLTIDLGGGYLWVNCEKGNYVSSTSKPTLCTSSQCSLFASHGCNSENICARSPTNTITGVSSYGDIHSDIVSVQSTDGNNPGRVVSVPNFLFICGSNVVQKDLAKGVKGMAGLGRTKVSIFSQFSSAFSFNRKFAICLGSSTRSKGVLFFGDGPYNLNMDVSKTLTFTPLVTNPFSTSPSSFLGEPSYEYFIDVKSIRVSGKNVPLNKTLLKIDTKNGVGGTKISTVNPYTIMETSIYKAVVDAFVKELGAPTVEPVAPFGTCFATKDISFSRMGPGVPSIDFVLQNEDVLWSIIGANSMVSLENDVICLGFVDAGSNPKASQVGFVVGGSKPMTSITIGAHQLENNFLQFDLAASRLGFRSLFLEHTNCDNFNFTSSV

SEQ ID NO: 64 - protein, 411 aa, Cicer arietinum
MASFSIFLPLFFSLLSLVSSSPNSLLLPITKDTTTLQYLTTLSYGTPFLPTKLVVDLTGSLFWLHCSSRKTPSFSLRTIPHRSLQCLTAKTNQTFEFPIDQNHPCQILTENTITGKVATDGKLVEDVVAFKSTKDSIFEHAHDFLFTCSHTLLLNGLSSDAKGIVGFGRSRTSFSSQVFNSINSQRKITFCLSSSSGFVQLGSTSTVFESSTKSEIFRSLTFTPLVESQNHESFINVKSIKIGGKKVSFNTPSLSQEGNSGTKLSSIVPYTTIQSSIYGNFKSAFLKAAFSMNMTRVTSVAPFDVCFDSNGIDESKVGPNVPVIDFVLQSEMVKWSIYGRNSMVKLSDDVMCLGLLDGGVEQKNPIVIGGYQFEDVLVQFDFDSSMVGFSSSLLMRDSSCSNFRFGSISSQ

SEQ ID NO: 65 - protein, 474 aa, Cicer arietinum
MTKNITTLLLLLLVGVTITLCEDEEREKGSSSSNKLFLMQDSKSVVKTDAGEMRLFQNKDTEFLDRNMHIGLINMEPRSLFIPQYLDSNFIIFVRRGDAKLGFIYGDELEERRLKTGDIYVIPAGSVFYLVNIGEGQRLHLICSIDPSTSLGDTFQPFYIGGGDNSQSVLAGFEPVILETAFNESREKLERIFSKKVDGPIVYIDDSHAPSLWTKFLQLKKEEKVQHLNKMVQGQEENNEEKKQTSWSWRKLFQSVLGEENKNIENKDRGDSPDSYNLYDRKHDFKNGYGWSSALDGDDYSLLKIPDIGVFHVNLTAGSMMVPHVNPRATEYGIVLRGSGRIQILFPNGSNAMDTEIKVGDIFYVPRYFPFCQIASRNGALEFFGFTTSSKKSNPQFLVGAASLLKTIMGPELAAGFGVREDIMRDVVGAQHDAVIVSSTWAAPGTGGVREEDAYVQSKGIIGIFDDILMDDFE

SEQ ID NO: 66 - protein, 593 aa, Cicer arietinum
MATTTKTRFPLLLLLGIIFLASVCVSYGIVQYEQGNPCLKKCMQRYNKVNEAFKRREEEEYEERSEHSVPGQRERGRQEGEKEEEHREQRRSRRESEREREEDEQKQRHPHHEREEEEDEEFRERRHRGDTEETRFRRRKERRQEQQEKKSESKEDEEESSSESQGRRNPFFFRSNKFQTIFENQHGHIRLLQNFDKRSNLFQNLQNYRFLEYKARPHTLLLPQHIDADFILVVLSGKAILTVLNPNDRNSFNLERGDTIKLPAGTTAYLANHDDEEDLRVVELAIPVNRPGKFQSFFPSSNQNQQSYFNGFSKSILEASFNTKYETIERVLLEEQEPEQSRGRRGSEESEEGDAIVKVSREQIEELSKHAKSSSRKSISSESEPFNLRSRNPIYSNKFGKFFEITPEKSPQLQDLNIFVSCVEINEGGLMLPHFNSRAIVVLFINEGKGHLELVGLRNEQQEQQQEEDEEQEEEERNNQVQRFRARLSPGDVFIIPAGHPVAVNASSDLNFVGFGINAENNQRNFLAGEDDNVISQIQNPVKELTFPGSAQEVNRLIKNQRQSYFANAQPQQREEESQRRRGSLSSILGGFY

SEQ ID NO: 67 - protein, 446 aa, Cicer arietinum
MAIKARFPLLVLLGIVFLASVCAKSDKENPFFFKSNNCQTLFENENGHVRLLQRFDKRSQLFENLQNYRLMEYNSKPHTLFLPQHNDADFILVVLRGRAILTVLNPNDRNTFKLERGDTIKLPAGTIAYLANRDDNEDLRVLDLAIPVNRPGQFQSFSLSGNENQQSYFQGFSKKILEASFNSDYEEIERVLLEEQEQKPEQRRGHKGRQQSQETDVIVKISREQIEELSKNAKSNCKKSVSSESEPFNLRSRSPIYSNRFGNFFEITPEKNPQLKDLDIFVNSVEIKEGSLLLPHFNSRATVILVVNEGKGEVELVGLRNENEQENKKEDEEEEEDRNVQVQRFQSKLSSGDVVVIPASHPFSINASSDLFLLGFGINAQNNQRNFLAGEEDNVISQIQRPVKEVAFPGSAEEVDRLLKNQRQSHFANAQPQQKRKGSQRIRSPF

SEQ ID NO: 68 - protein, 455 aa, Cicer arietinum
MAIKARFPLLVLLGIVFLASVCAKSDKENPFFFKSNNFQTLFKNENGHVRLLQRFDKRSQLFENLQNYRLVEYNSKPHTLFLPQHNDADFILVVLSGRAILTVLNPNDRNTFKLERGDTIKLPAGTIAYLANRDDNEDLRVLDLAIPVNRPGQFQSFSLSGSENQQSYFQGFSKKILEASFNSDYEEIERVLLEEQEQKPKQRRGHKDRQQSQRQEADVIVKISREQIEELSKNAKSSSKRSVSSESEPFNLRSRNPIYSNKYGNFFEITPEKNPQLQDLDISLNSVEINEGSLLLPHFNSRATVILVVNEGKGEVELVGLRNENEQENKKEDEEEEEDRNVQVQRFQSKLSSGDVVVIPASHPFSINASSDLFLLGFGINAQNNQRNFLAGEEDNVISQIQRPVKEVAFPGSAEEVDRLLKNQRQSHFANAQPQQKDEGSQKIRIPLSSILGGF

SEQ ID NO: 69 - protein, 488 aa, Cicer arietinum
MRDKATLLIMLLILCHGVAMTKGLWEIKNEDREDHGPQMPEKLFLLQNSKRVVKTDAGEMRVLESYGGRVSERRLHIGFINMEPSSLFVPQYLDSTLIVFVRSGEAKVGFIYEDELAERELKRGDVYQIPAGSAFYLLNIGKAQKLHIICSIDPSESLGIGIFQSFYIGGGAPVSVLSGFEPQILETAFNASEAELIKFFTRQHEGPIVHIGDSHVSASSLWNKFLQLKEDEKLNHLKKLVQDQEEDEDDEEKEEEKPQPSWSWRKLLESVFGDEMKKNKKDKVSHKSPHSCNLYDRKPDFKNTYGWSVALDGSDYSPLKTSGIGIYHVNLKPGSMMTPHVNPRATEYGMVVKGSGRIQIVFPNGSNAMDTHIKEGDVFFVPRYFAFCQIASKNEPLDFFGFTTSSRKNKPQFLVGATSLMKTMMGPELAAAFGVSEDTMRHILNAQHEAVILPTPWTESKQNYGNKLDLESLPTTKVVTNDDMIIGF

SEQ ID NO: 70 - protein, 458 aa, Cicer arietinum
MAIKARFPLLVLLGIVFLASVCAKSNKENPFFFKSNNFQTLFKNENGHVRLLQRFDKRSQLFENLQNYRLVEYNSKPHTLFLPQHNDADFILVVLSGRAILTVLNPNDRNTFNLERGDTIKLPAGTIAYLANRDDNEDLRVLDLAIPVNRPGQFQSFSLSGSENQQSYFQGFSKKILEASFNSDYEEIERVLLEEQEQKPKQRRGHKDRQQSQSQSQQEADVIVKISREQIEELSKNAKSSSKKSVSSESEPFNLRSRNPIYSNKYGNFFEITPEKNPQLQDLDISLNSVEINEGSLLLPHFNSRATVILVVNEGKGEVELVGLRNENEQENKKEDEEEEEDRNVQVQRFQSRLSSGDVVVIPASHPFSINASSDLFLLGFGINAQNNQRNFLAGEEDNVISQIQRPVKEVAFPGSAEEVDRLLKNQRQSHFANAQPQQKDEGSQKIRIPLSSILGGF

SEQ ID NO: 71 - protein, 138 aa, Cicer arietinum
MAYVKLPPLTLFLLATFLITFSTKKVGATCTGVCSFYDSNPCGGNYCFCHFLDVGDYKGICIDRSFFIKTVDEDPNLCQTHAECTKKGSGNFCGRYPNPNIKYGRCFASNTEAEEFSNKFSYYSSRFIKDFLNMPVVA

SEQ ID NO: 72 - protein, 147 aa, Cicer arietinum
MAKHIFLVTFFVALILFIAHTNASKDEKEEIPESCHKQLKSLNLKHCEKFLMKRMQKDEDEDDDNVIKMRGVNYIRNREEGLKENCCAQLSEVNFLDCRCEALQKIGDNLSDKCDKKEMEEMERELKILPLRCGITPPLGCDLSFDN

SEQ ID NO: 73 - protein, 149 aa, Cicer arietinum
MSMGEVEQNNYGTEFEKGVDSAYRSSYGNEVYLFKGDKYACIDYGTNRLVQSIKKISDGFTCFHDTIFENGIDAAFASHRTDEAYFFKGEYYVRVAVVPGSTSDKLMGNPAKIVDYWPSLRGLIPLKNQYQSIITKNKHSFLFIFLCIM

SEQ ID NO: 74 - protein, 222 aa, Cicer arietinum
MSNLSIDAAYRSSVHNECYIFVKERYVVVNYNPGGKKEKIIHGPKHISDGFPMLIGTEFEKGIDCAFDGDNNEAYIFSGKYGGKIDYVNLTLLKDKTPIKDMFPSLKDTKLVNGIDAGIRSTGKDVFLFKGDEYVRIDYQSELVKSNKYIRTGFQSLVGTVFEFGIDAAFASHVQNEAYIFKGDYYARINVAPGTASGDFIVGGRIKRIHDDWPALHSILKN

SEQ ID NO: 75 - protein, 230 aa, Cicer arietinum
MTNFGYINAAFRSSRNNEAYLFINDKYVLLDYAPGTTNDKVLYGPSFVRDGYKSLANTIFGTYGIDCAFDTDNNEAFIFYEKFCALIDYAPHSNKDKIILGPKKIVDMFPFFEGTMFENGIDAAFRSTKGKEVYLFKGDKYARIDYETNRLIQNIKDITDGFPCLRGTIFENGIEAAFASHKTNEAYLFKGEYYARIHFTPGSTNDTIMGGVKNTLDYWPSLQGIIPMKN

SEQ ID NO: 76 - protein, 230 aa, Cicer arietinum
MTKSGYIDAAFRSSRNNEAYLFINDKYVLLDYAPGTSNDKVLYGPSLVRDGYKSLAKTIFGTYGIDCSFDTEYNEAFIFYENLCARIDYAPHSDKDKIISGPKKIADMFPFFKGTVFENGIDAAFRSTKGKEVYLFKEDKYARIDYGTNRLVQNIKYISDGFPCLRGTIFEYGMDSAFASHKTNEAYLFKGEYYARINFTPGSTNDTIMGGVKKTLDYWPSLRGIIPQNN

SEQ ID NO: 77 - protein, 418 aa, Lens culinaris
SRSDQENPFIFKSNRFQTIYENENGHIRLLQRFDKRSKIFENLQNYRLLEYKSKPHTIFLPQFTDADFILVVLSGKAILTVLNSNDRNSFNLERGDTIKLPAGTIAYLANRDDNEDLRVLDLAIPVNRPGQLQSFLLSGTQNQPSFLSGFSKNILEAAFNTEYEEIEKVLLEEQEQKSQHRRSLRDKRQEITNEDVIVKVSREQIEELSKNAKSSSKKSVSSESEPFNLRSRNPIYSNKFGKFFEITPEKNPQLQDLDIFVNSVEIKEGSLLLPNYNSRAIVIVTVNEGKGDFELVGQRNENQQEQREENDEEEGQEEETTKQVQRYRARLSPGDVLVIPAGHPVAINASSDLNLIGFGINAKNNQRNFLAGEEDNVISQIQRPVKELAFPGSSREVDRLLTNQKQSHFANAQPLQIE

SEQ ID NO: 78 - protein, 415 aa, Lens culinaris
SRSDQENPFIFKSNRFQTIYENENGHIRLLQKFDKRSKIFENLQNYRLLEYKSKPHTLFLPQYTDADFILVVLSGKAVLTVLNSNDRNSFNLERGDTIKLPAGTIAYLANRDDNEDLRVLDLAIPVNNPGQLESFLLSGTQNQPSFLSGFNKSILEAAFNTDYEEIEKVLLEDQEQEPQHRRSLRDRRQEINKENVIVKVSREQIKELSKNAKSSSKKSVSSESEPFNLRSRNPIYSNKFGKFFEITPEKNPQLQDLDIFVNSVEIKEGSLLLPNYNSRAIVIVTVNEGKGYFELVGQRNENQREENDDEEEQEEETSTQVQRYRAKLSPGDVFVVPAGHPVAINASSDLNLIGFGINAKNNQRNFLAGEEDNVISQIQRPVKELAFPGSSREVDRLLTNQKQSHFANAQPLQIE

SEQ ID NO: 79 - protein, 518 aa, Lens culinaris
MATTIKSRFPLLLLLGIIFLAFVCVAYANDDEGSEPRVTGQRERGRQEGEKAEQSREQSPGQWRPSHGKEEDEEEKEQKEAQSGREKWERKEDEEKVVEEEEGEWRGSQRHGDPEERSRQRHREEKTKRQVEEQTEEKDRRYQHEGKEEETSSESQERRNPFLFKSNKFLTLFENENGHIRRLQRFDKRSDLFENLQNYRLVEYRAKPHSIFLPQHIDAEFIVVVLSGKAILTVLSPNDRNSYNLERGDAIKSPAGATYYLVNPDDEEDLRVVDFVISLNRPGKFEAFDLSANRRQYLRGFSKSVLEASLNTKYDTIEKVLLEEQENEPHQRRDRKGRPQGQEKHAIVKVSREQIEELRRLAKSSSKKSLPSEFEPFNLRSQNPKYSNKFGKFFEVTPEKKYPQLQDLDLLVSSVEINEGGLLLPHYNSRAIVVLLVNEGKGNLELVGFKNEQQEREDNKERNNEVQRYEARLSPGDVVIIPAGHPVSISASSNLNLLGFGINAENNERNFLTGSDDN

SEQ ID NO: 80 - protein, 418 aa, Lens culinaris; identical to SEQ ID NO: 77